(19) United States
(12) Patent Application Publication
(10) Pub. No.: US 2010/0057685 A1
(43) Pub. Date: Mar. 4, 2010

(54) INFORMATION STORAGE AND RETRIEVAL SYSTEM

(75) Inventors: Gerhard Luhn, Radebeul (DE); Johann Harter, Dresden (DE); Franz Kreupl, Muenchen (DE)

Correspondence Address: DICKE, BILLIG & CZAJA, FIFTH STREET TOWERS, 100 SOUTH FIFTH STREET, SUITE 2250, MINNEAPOLIS, MN, 55402, US

(73) Assignee: Qimonda AG, Muenchen (DE)

(21) Appl. No.: 12/202,869

(22) Filed: Sep. 2, 2008

(51) Int. Cl. G06F 7/06; G06F 17/30

(52) U.S. Cl. 707/3; 707/100; 707/E17.044; 707/E17.014

(57) ABSTRACT

An information storage and retrieval system includes a first data structure and a second data structure. The first data structure is configured to store documents. Each document includes a plurality of data portions. The second data structure is configured to store addresses to each document and data portion stored in the first data structure at addresses defined by an identity of each data portion.

### BACKGROUND

Typical information storage and retrieval systems, such as internet search engines, store documents in special file systems (e.g., document databases). The documents are typically searched and retrieved via a classical von Neumann architecture. As the internet has grown, so has the amount of information to be stored and retrieved. The information is typically stored in database data structures and indexes in a memory or hard disk. The database data structures and indexes may be stored in any suitable form including ordered or unordered flat files, indexed sequential access mode (ISAM), heaps, hash buckets, or B+ trees. Each of these structures, however, depends heavily on search algorithms executed by central processing units (CPUs) to search in the index files for a specific result.

The database data structures and indexes may be searched using binary search algorithms, linear searches, or hash data structures. All these search techniques, however, use a run-time process executed by a CPU to evaluate a query on a given database. To enable the processing of millions of queries per second, the query task is distributed to several hundred or thousands of servers simultaneously. The servers are typically grouped together in server farms. The server farms consume large amounts of electrical power. Typically, approximately half of the electrical power consumed by a server farm is used for cooling of the server farm. Most of the remaining half of the electrical power consumed by a server farm is due to the CPU and power supply of each server.

For these and other reasons, there is a need for the present invention.

### SUMMARY

One embodiment provides an information storage and retrieval system. The system includes a first data structure and a second data structure. The first data structure is configured to store documents. Each document includes a plurality of data portions. The second data structure is configured to store addresses to each document and data portion stored in the first data structure at addresses defined by an identity of each data portion.

### BRIEF DESCRIPTION OF THE DRAWINGS

The accompanying drawings are included to provide a further understanding of embodiments and are incorporated in and constitute a part of this specification. The drawings illustrate embodiments and together with the description serve to explain principles of embodiments. Other embodiments and many of the intended advantages of embodiments will be readily appreciated as they become better understood by reference to the following detailed description. The elements of the drawings are not necessarily to scale relative to each other. Like reference numerals designate corresponding similar parts.

FIG. 1 is a block diagram illustrating one embodiment of an information storage and retrieval system.

FIG. 2A is a diagram illustrating one embodiment of an informer data structure.

FIG. 2B is a diagram illustrating another embodiment of an informer data structure.

FIG. 3A is a diagram illustrating one embodiment of a document storage data structure.

FIG. 3B is a diagram illustrating another embodiment of a document storage data structure.

FIG. 3C is a diagram illustrating one embodiment of header content of a header field of a document storage data structure.

FIG. 4 is a diagram illustrating one embodiment of a document rank data structure.

FIG. 5 is a block diagram illustrating another embodiment of an information storage and retrieval system.

FIG. 6 is a diagram illustrating one embodiment of a word reference data structure.

FIG. 7A is a diagram illustrating one embodiment of an informer data structure.

FIG. 7B is a diagram illustrating another embodiment of an informer data structure.

FIG. 8 is a flow diagram illustrating one embodiment of a method for storing a document.

FIG. 9A is a flow diagram illustrating one embodiment of a method for processing a word within a document being stored.

FIG. 9B is a flow diagram illustrating another embodiment of a method for processing a word within a document being stored.

FIG. 10A is a flow diagram illustrating one embodiment of a method for directly accessing stored documents.

FIG. 10B is a flow diagram illustrating another embodiment of a method for directly accessing stored documents.

FIG. 11A is a flow diagram illustrating another embodiment of a method for directly accessing stored documents.

FIG. 11B is a flow diagram illustrating another embodiment of a method for directly accessing stored documents.

FIG. 12A is a flow diagram illustrating another embodiment of a method for directly accessing stored documents.

FIG. 12B is a flow diagram illustrating another embodiment of a method for directly accessing stored documents.

FIG. 13 is a diagram illustrating one embodiment of a word reference data structure including example data.

FIG. 14A is a diagram illustrating one embodiment of an informer data structure including example data.

FIG. 14B is a diagram illustrating another embodiment of an informer data structure including example data.

FIG. 15 is a diagram illustrating one embodiment of a document storage data structure including example data.

FIG. 16A is a diagram illustrating one embodiment of an informer data structure including example data.

FIG. 16B is a diagram illustrating another embodiment of an informer data structure including example data.

FIG. 17 is a diagram illustrating one embodiment of a word reference data structure for handling long words.

FIG. 18 is a diagram illustrating one embodiment of an informer data structure for handling long words.

FIG. 19 is a flow diagram illustrating another embodiment of a method for directly accessing stored documents.

FIG. 20 is a diagram illustrating another embodiment of a word reference data structure including example data.

FIG. 21 is a diagram illustrating another embodiment of an informer data structure including example data.

FIG. 22 is a diagram illustrating one embodiment of a word reference data structure for handling double words.

FIG. 23 is a diagram illustrating one embodiment of an informer data structure for handling double words.

FIG. 24 is a flow diagram illustrating another embodiment of a method for directly accessing stored documents.

FIG. 25 is a diagram illustrating another embodiment of a word reference data structure including example data.

FIG. 26 is a diagram illustrating another embodiment of an informer data structure including example data.

FIG. 27 is a block diagram illustrating another embodiment of an information storage and retrieval system.

FIG. 28 is a diagram illustrating one embodiment of a long word reference data structure.

FIG. 29 is a flow diagram illustrating another embodiment of a method for directly accessing stored documents.

FIG. 30A is a block diagram illustrating one embodiment of hardware for accessing stored documents in the information storage system.

FIG. 30B is a block diagram illustrating another embodiment of hardware for accessing stored documents in the information storage system.

### DETAILED DESCRIPTION

In the following Detailed Description, reference is made to the accompanying drawings, which form a part hereof, and in which is shown by way of illustration specific embodiments in which the invention may be practiced. In this regard, directional terminology, such as “top,” “bottom,” “front,” “back,” “leading,” “trailing,” etc., is used with reference to the orientation of the Figure(s) being described. Because components of embodiments can be positioned in a number of different orientations, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims.

It is to be understood that the features of the various exemplary embodiments described herein may be combined with each other, unless specifically noted otherwise.

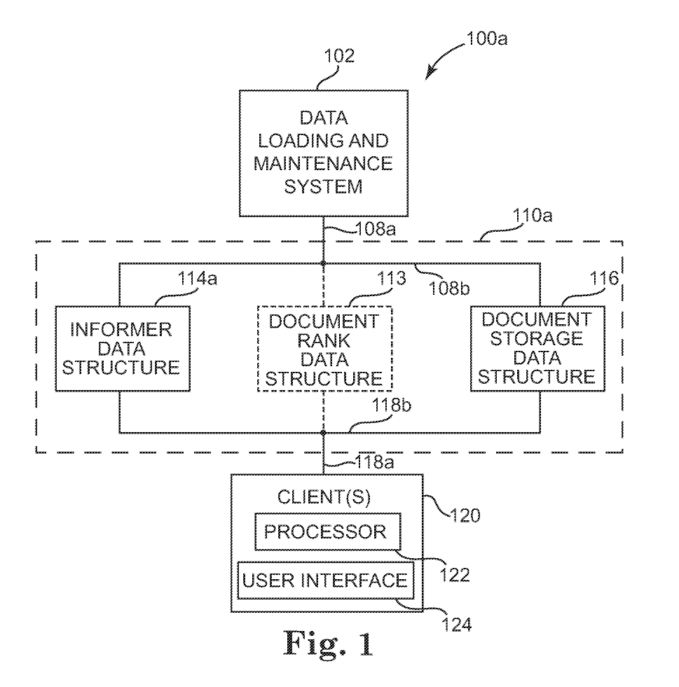

FIG. 1 is a block diagram illustrating one embodiment of an information storage and retrieval system 100a. Information storage and retrieval system 100a includes a data loading and maintenance system 102, an information storage system 110a, and one or more clients 120. Information storage system 110a includes an informer data structure 114a, a document storage data structure 116, and optionally a document rank data structure 113. In one embodiment, each client 120 is a computer including a processor 122 and a user interface 124.

Information storage system 110a stores documents for retrieval by clients 120. As used herein, the term “document” refers to any suitable type of data file, such as text, pictures, sounds, multimedia, etc. The documents are stored in document storage data structure 116 and are directly accessed by using addresses stored in informer data structure 114a. Clients 120 directly access the documents stored in document storage data structure 116 without executing any search queries on information storage system 110a. Each client 120 directly accesses documents stored in document storage data structure 116 based on the identity of each of one or more search terms provided by the client. In one embodiment, the identity of each of the one or more search terms is a coded value for each of the one or more search terms.

The coded value for each search term provides an address within informer data structure 114a for obtaining associated document-word addresses from informer data structure 114a. The document-word addresses from informer data structure 114a provide the addresses within document storage data structure 116 for obtaining associated documents or portions of documents from document storage data structure 116 that use the search terms. In this way, clients 120 directly access the documents or portions of documents based on the search terms. By directly accessing the documents, server based processors are not needed for processing queries to information storage system 110a. Therefore, the number of servers and the associated server farms may be reduced such that information storage and retrieval system 100a uses substantially less power than typical information storage and retrieval systems.

In one embodiment, data loading and maintenance system 102 includes one or more processors and one or more crawlers. Data loading and maintenance system 102 is communicatively coupled to information storage system 110a through communication link 108a. In one embodiment, data loading and maintenance system 102 is communicatively coupled to informer data structure 114a, document storage data structure 116, and to optional document rank data structure 113 through communication links 108a and 108b. In one embodiment, communication link 108a is external to information storage system 110a, and communication link 108b is internal to information storage system 110a.

Information storage system 110a is communicatively coupled to clients 120 through communication link 118a. In one embodiment, informer data structure 114a, document storage data structure 116, and optional document rank data structure 113 are communicatively coupled to clients 120 through communication links 118a and 118b. In one embodiment, communication link 118b is internal to information storage system 110a, and communication link 118a is external to information storage system 110a. In one embodiment, communication link 118a is an internet communication link.

Data loading and maintenance system 102 searches websites and/or other suitable information sources for documents or other suitable content (e.g., multimedia files) to add to information storage system 110a. Data loading and maintenance system 102 writes the documents to document storage data structure 116 of information storage system 110a. Data loading and maintenance system 102 stores the document-word address for each usage of each word or data portion stored in document storage data structure 116 to informer data structure 114a at the associated identity of each word or data portion, such as at the coded value of each word or data portion.

In one embodiment, information storage system 110a includes a network attached dedicated memory controller that responds to three commands including write, read, and send back to query. In one embodiment, information storage system 110a supports up to 100*10¹⁰ documents with each document having up to 100*10⁴ characters. This equals 10¹⁸ bytes or 1 exabyte of information. In one embodiment, information storage system 110a supports up to 10⁸ words for each of up to ten languages for a total of up to 10⁹ words. In other embodiments, information storage system 110a is downscaled for storing up to several hundred petabytes of information. In addition, information storage system 110a can support multimedia objects (e.g., pictures, sounds, etc.) by using a suitable code associated with each multimedia object.

Clients 120 include a processor 122 for directly accessing informer data structure 114a, document storage data structure 116, and optionally document rank data structure 113 of information storage system 110a without executing queries on processors of information storage system 110a. In one embodiment, user interface 124 of each client 120 includes an output device, such as a display, and an input device, such as a keyboard, mouse, etc. User interface 124 is used to enter a search term or terms for accessing documents stored in information storage system 110a. The search term or terms are transformed to their coded values by processor 122 of the client. Processor 122 uses the coded values to directly access the documents or portions of the documents stored in document storage data structure 116 that include the search term or terms. In one embodiment, processor 122 then provides and/or displays the accessed documents or portions of the documents through user interface 124. In one embodiment, processor 122 provides or displays a predefined number of words before and after each search term within each accessed document.

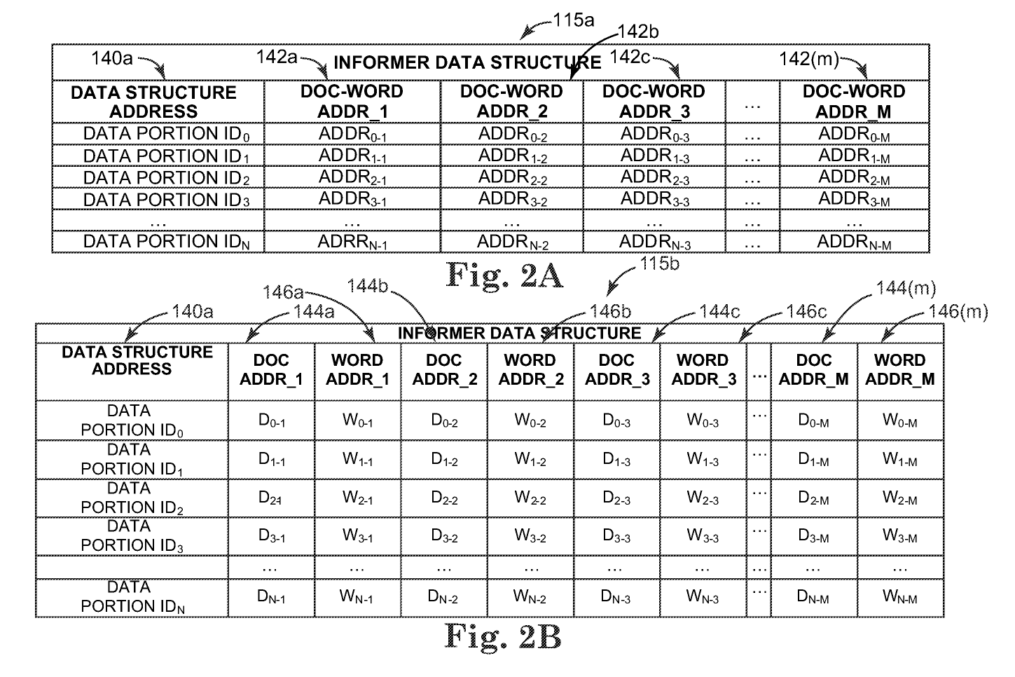

FIG. 2A is a diagram illustrating one embodiment of an informer data structure 115a. In one embodiment, informer data structure 115a provides informer data structure 114a of information storage system 110a previously described and illustrated with reference to FIG. 1. Informer data structure 115a stores document-word addresses in document-word address 1 (DOC-WORD ADDR_{—}1) through document-word address M (DOC-WORD ADDR_M) fields 142a-142(m) at data structure addresses 140a defined by data portion identities. In one embodiment, each data portion identity is the coded value of a word. Each document-word address is an address within document storage data structure 116 where the associated word is used.

Document-word addresses ADDR₀₋₁ up to ADDR_{0-M} are stored at the address defined by DATA PORTION ID₀. The document address portion of the document-word addresses ADDR₀₋₁ up to ADDR_{0-M} may be repeated since the same word may be used several times within a single document. Likewise, document-word addresses ADDR₁₋₁ up to ADDR_{1-M} are stored at the address defined by DATA PORTION ID₁. Informer data structure 115a includes any suitable number “N” of data portions and any suitable number “M” of document-word address fields, such that document-word addresses ADDR_{N-1} up to ADDR_{N-M} are stored at the address defined by DATA PORTION ID_{N}. In one embodiment, each data structure address 140a includes 48-bits such that informer data structure 115a can include 10¹⁴ data structure addresses and associated document-word addresses.

In one embodiment, a limited number of document-word addresses for a word instance within each document are stored. Therefore, not all the document-word addresses for commonly used words, such as “the”, “of”, “and”, “to”, “a”, “in”, “that”, “is”, “was”, etc. within each document are stored. In one embodiment, up to the first ten instances of each word used in a document are stored within informer data structure 115a. In other embodiments, another suitable limit is used.

FIG. 2B is a diagram illustrating another embodiment of an informer data structure 115b. In one embodiment, informer data structure 115b provides informer data structure 114a of information storage system 110a previously described and illustrated with reference to FIG. 1. Informer data structure 115b stores document addresses in document address 1 (DOC ADDR_{—}1) through document address M (DOC ADDR_M) fields 144a-144(m) and word addresses in word address 1 (WORD ADDR_{—}1) through word address M (WORD ADDR_M) fields 146a-146(m) at data structure addresses 140a defined by data portion identities. In one embodiment, each data portion identity is the coded value of a word. One or more document addresses D are stored at each data structure address 140a. One or more word addresses W are also stored at each data structure address 140a. Each document address and word address provides an address within document storage data structure 116 where the associated word is used.

Document addresses D₀₋₁ up to D_{0-M} and word addresses W₀₋₁ up to W_{0-M} are stored at DATA PORTION ID₀. The document addresses stored at a data structure address may be repeated since the same word may be used several times within a single document. For example, D₀₋₁ may equal D₀₋₂, which may equal D₀₋₃, etc. Likewise, document addresses D₁₋₁ up to D_{1-M} and word addresses W₁₋₁ up to W_{1-M} are stored at DATA PORTION ID₁. Informer data structure 115b includes any suitable number “N” of DATA PORTION IDs and any suitable number “M” of document address and word address fields, such that document addresses D_{N-1} up to D_{N-M} and word addresses W_{N-1} up to W_{N-M} are stored at DATA PORTION ID_{N}. In one embodiment, each data structure address 140a includes 30-bits such that informer data structure 115b can include 10⁹ word-reference addresses and associated document addresses and word addresses.

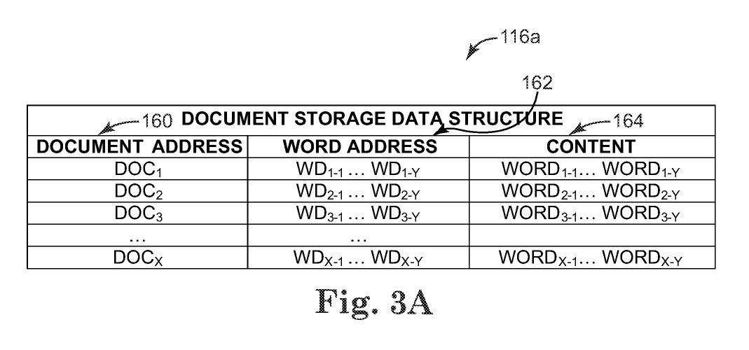

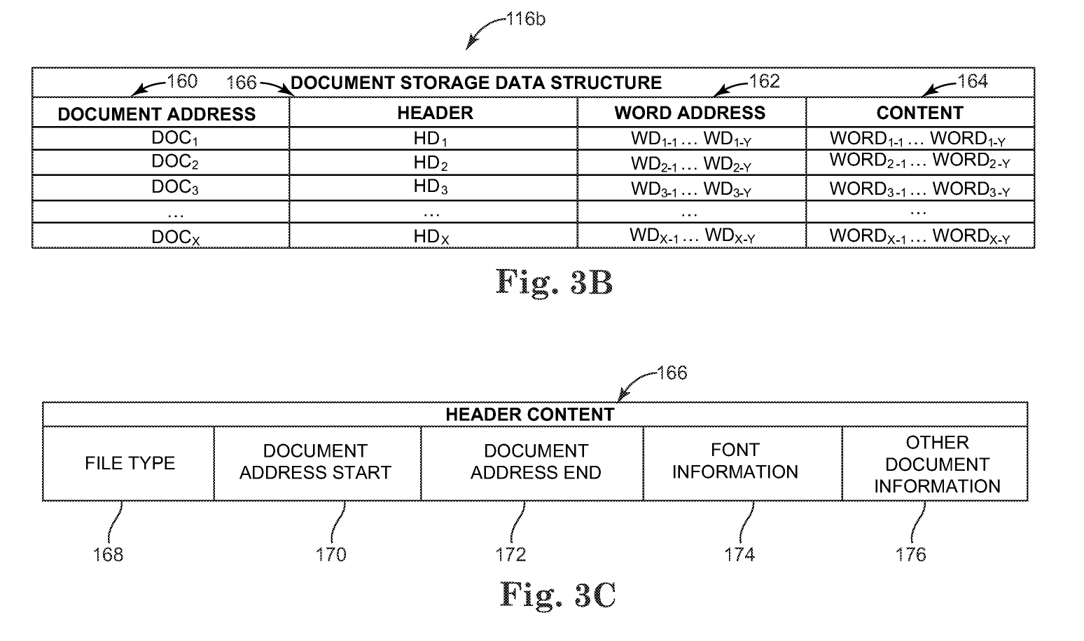

FIG. 3A is a diagram illustrating one embodiment of a document storage data structure 116a. In one embodiment, document storage data structure 116a provides document storage data structure 116 of information storage system 110a previously described and illustrated with reference to FIG. 1. Document storage data structure 116a stores content 164 at document addresses 160 and word addresses 162. In one embodiment, each document address 160 corresponds to a document address portion of a document-word address stored in a field 142a-142(m) of informer data structure 115a. In another embodiment, each document address 160 corresponds to a document address stored in a field 144a-144(m) of informer data structure 115b. In one embodiment, each word address 162 corresponds to a word address portion of a document-word address stored in a field 142a-142(m) of informer data structure 115a. In another embodiment, each word address 162 corresponds to a word address stored in a field 146a-146(m) of informer data structure 115b.

WORD₁₋₁ to WORD_{1-Y} of a first document are stored at document address DOC₁ and word addresses WD₁₋₁ to WD_{1-Y}, respectively. As such, the first word (i.e., WORD₁₋₁) of the first document stored at document address DOC₁ is stored at word address WD₁₋₁, and the last word (i.e., WORD_{1-Y}) of the first document stored at document address DOC₁ is stored at word address WD_{1-Y}. Likewise, WORD₂₋₁ to WORD_{2-Y} of a second document are stored at document address DOC₂ and word addresses WD₂₋₁ to WD_{2-Y}, respectively. Document storage data structure 116a stores any suitable number “X” of documents up to address DOC_{X} where each document includes any suitable number “Y” of words, such that WORD_{X-1} to WORD_{X-Y} of a last document are stored at document address DOC_{X} and word addresses WD_{X-1} to WD_{X-Y}, respectively.

FIG. 3B is a diagram illustrating another embodiment of a document storage data structure 116b. In one embodiment, document storage data structure 116b provides document storage data structure 116 of information storage system 110a previously described and illustrated with reference to FIG. 1. Document storage data structure 116b is similar to document storage data structure 116a previously described and illustrated with reference to FIG. 3A, except that document storage data structure 116b includes an additional header field 166. The header (HD) of each document stores any suitable data about the document.

FIG. 3C is a diagram illustrating one embodiment of header content of header field 166 of document storage data structure 116b. The header content includes the document file type 168, the document address start 170, the document address end 172, the document font information 174, and any other suitable document information 176. In other embodiments, the header content includes other suitable information about the stored document. File type 168 indicates the type of the document stored in document storage data structure 116b. The file type indicates any suitable file type, such as text, jpeg, bitmap, PDF, MP3, etc.

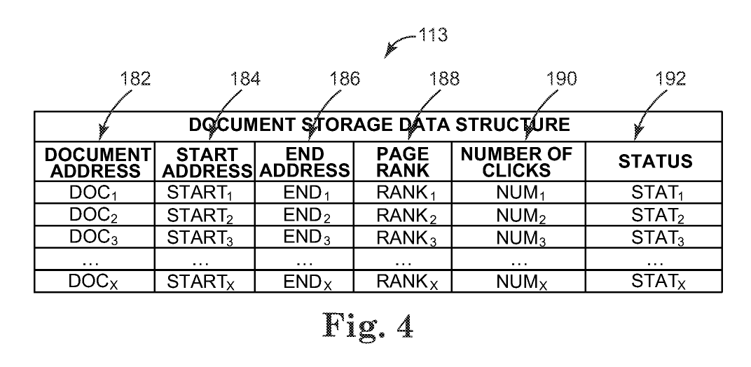

FIG. 4 is a diagram illustrating one embodiment of a document rank data structure 113. Document rank data structure 113 stores document start addresses 184, document end addresses 186, page rank 188, number of clicks 190, and status 192 at document addresses 182. In one embodiment, each document stored in document storage data structure 116 is ranked and the ranking information is used to order the results provided to a client 120.

In one embodiment, the page rank 188 is determined at the time a document is stored to document storage data structure 116 and is updated at a suitable interval. In one embodiment, the page rank 188 is based on the number of links to the document on the internet. The number of clicks 190 is the number of times the document has been selected by a client 120. The status 192 provides other information regarding the document, such as when the document was added to document storage data structure 116, when the document was last updated in document storage data structure 116, and/or other suitable status information.

For example, the start address START₁ in document storage data structure 116, the end address END₁ in document storage data structure 116, the rank RANK₁, the number of clicks NUM₁, and the status STAT₁ for document DOC₁ stored in document storage data structure 116 is stored at document address DOC₁ in document rank data structure 113. In one embodiment, a client 120 calculates a final document ranking for each document by multiplying the page rank 186 times the number of clicks 190. For example, for DOC₁, the final document ranking equals RANK₁ times NUM₁.

In one embodiment, the start address and the end address are used to selectively update each document by address. For example, if DOC₁ is updated, then the updated document is stored in document storage data structure 116 beginning at START₁ and ending at END₁. Therefore, the prior version of DOC₁ is overwritten.

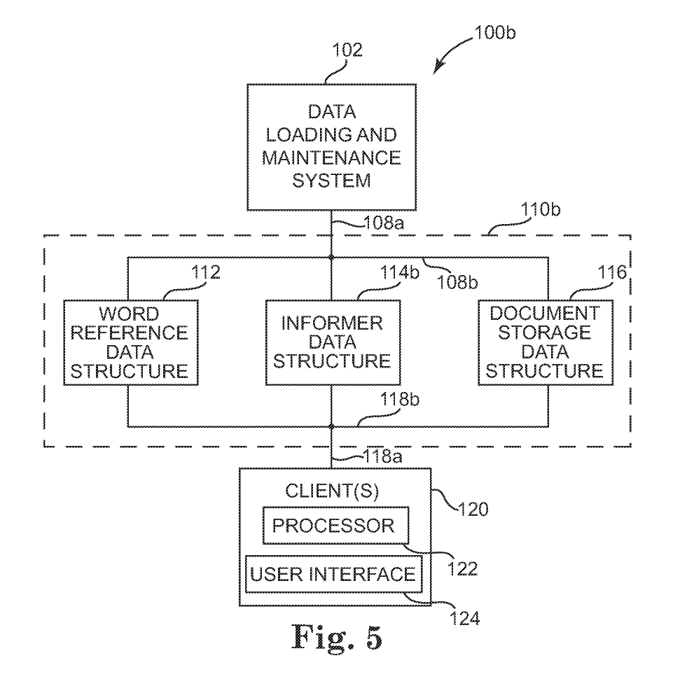

FIG. 5 is a block diagram illustrating another embodiment of an information storage and retrieval system 100b. Information storage and retrieval system 100b includes data loading and maintenance system 102, an information storage system 110b, and one or more clients 120. Information storage system 110b includes a word reference data structure 112, an informer data structure 114b, and a document storage data structure 116.

Information storage system 100b stores documents for retrieval by clients 120. The documents are stored in document storage data structure 116 and are directly accessed by using addresses stored in informer data structure 114b and word reference data structure 112. Clients 120 directly access the documents stored in document storage data structure 116 without executing any search queries on information storage system 110b. Each client 120 directly accesses documents stored in document storage data structure 116 based on a coded value for each of one or more search terms provided by the client.

The coded value for each search term provides an address within word reference data structure 112 for obtaining an associated word-reference address from word reference data structure 112. The word-reference address from word reference data structure 112 provides the address within informer data structure 114b for obtaining associated document-word addresses from informer data structure 114b. The document-word addresses from informer data structure 114b provide the addresses within document storage data structure 116 for obtaining associated documents or portions of documents from document storage data structure 116 that use the search terms. In this way, clients 120 directly access the documents or portions of documents based on the search terms. By directly accessing the documents, server based processors are not needed for processing queries to information storage system 110b. Therefore, the number of servers and the associated server farms may be reduced such that information storage and retrieval system 100b uses substantially less power than typical information storage and retrieval systems.

Data loading and maintenance system 102 searches websites and/or other suitable information sources for documents or other suitable content (e.g., multimedia files) to add to information storage system 110b. Data loading and maintenance system 102 provides the documents for writing to information storage system 110b. Data loading and maintenance system 102 writes the documents to document storage data structure 116 of information storage system 110b. Data loading and maintenance system 102 stores the document-word address for each usage of each word stored in document storage data structure 116 to informer data structure 114b at an associated word-reference address. Data loading and maintenance system 102 stores each word-reference address in word reference data structure 112 at an associated address for each word. The associated address for each word is the coded value of the word.

Clients 120 include a processor 122 for directly accessing word reference data structure 112, informer data structure 114b, and document storage data structure 116 of information storage system 110b without executing queries on processors of information storage system 110b. User interface 124 is used to enter a search term or terms for accessing documents stored in information storage system 110b. The search term or terms are transformed to their coded values by processor 122 of the client. Processor 122 uses the coded values to directly access the documents or portions of the documents stored in document storage data structure 116 that include the search term or terms. In one embodiment, processor 122 then provides and/or displays the accessed documents or portions of the documents through user interface 124. In one embodiment, processor 122 provides or displays a predefined number of words before and after each search term within each accessed document.

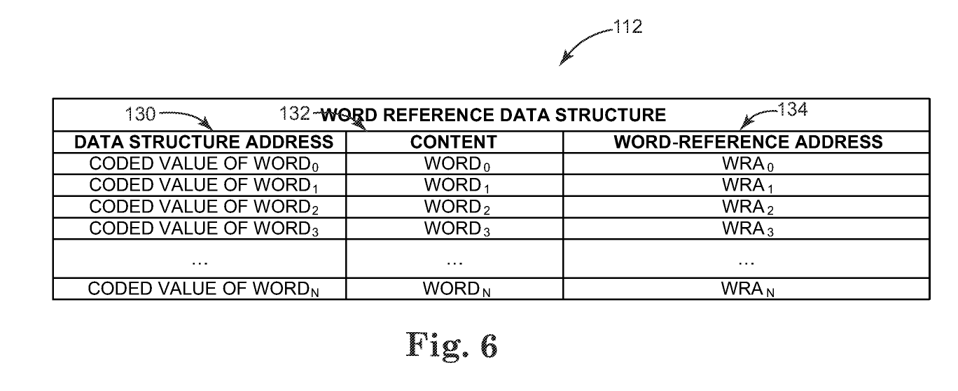

FIG. 6 is a diagram illustrating one embodiment of word reference data structure 112 of information storage system 110b. Word reference data structure 112 stores word-reference addresses 134 for content 132 at data structure addresses 130. Each address 130 of word reference data structure 112 is the coded value of the content 132. In one embodiment, the coded value of the content is the ASCII value of the content or another suitable code, such as a Huffman code. In one embodiment, content 132 includes a list of words WORD₀ through WORD_{N} that are used in documents stored in document storage data structure 116.

WORD₀ is stored at the coded value of WORD₀ and is associated with word-reference address WRA₀. Likewise, WORD_{N} is stored at the coded value of WORD₁ and is associated with word-reference address WRA₁. Word reference data structure 112 includes any suitable number “N” of words, such that WORD_{N} is stored at the coded value of WORD_{N} and is associated with word-reference address WRA_{N}. For each new word used in a document stored in document storage data structure 116, a new word-reference address is stored at the address in word reference data structure 112 that is equal to the coded value of the new word. In one embodiment, each word-reference address includes 30-bits such that up to 109 unique words can be stored in word reference data structure 112.

For example, in one embodiment the word “Paris” is stored at the ASCII coded value for “Paris”, which is “101 0000 110 0001 111 0010 110 1001 111 0011”. This address is also associated with a unique word-reference address. In one embodiment, each data structure address 130 includes 240-bits for representing words having up to 30 letters. In this embodiment, word reference data structure 112 includes 1.69*10⁷² addressable lines to address up to 10⁹ unique words. In other embodiments, each data structure address 130 includes less than 240-bits for representing words having less than 30 letters.

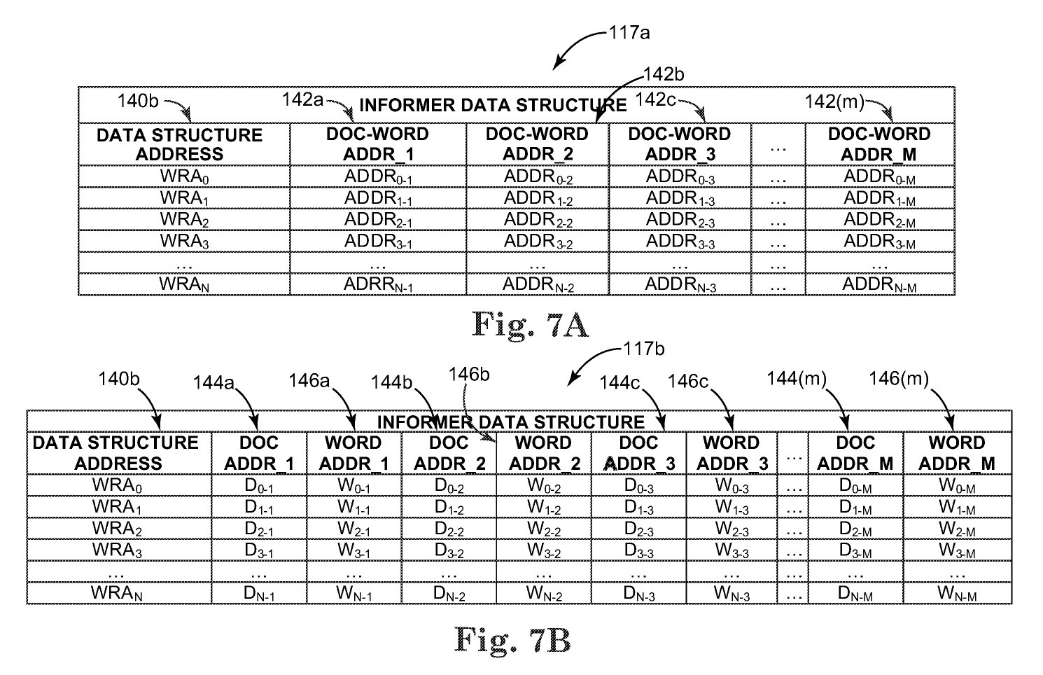

FIG. 7A is a diagram illustrating one embodiment of an informer data structure 117a. In one embodiment, informer data structure 11 7a provides informer data structure 114b of information storage system 110b previously described and illustrated with reference to FIG. 5. Informer data structure 117a stores document-word addresses in document-word address 1 (DOC-WORD ADDR_{—}1) through document-word address M (DOC-WORD ADDR_M) fields 142a-142(m) at data structure addresses 140b. Each word-reference address 134 stored in word reference data structure 112 corresponds to a data structure address 140b in informer data structure 117a. One or more document-word addresses ADDR are stored at each data structure address 140b. Each document-word address is an address within document storage data structure 116 where the associated content 132 from word reference data structure 112 is used.

Document-word addresses ADDR₀₋₁ up to ADDR_{0-M} are stored at word-reference address WRA₀. The document address portion of the document-word addresses ADDR₀₋₁ up to ADDR_{0-M} may be repeated since the same word may be used several times within a single document. Likewise, document-word addresses ADDR₁₋₁ up to ADDR_{1-M} are stored at word-reference address WRA₁. Informer data structure 117a includes any suitable number “N” of word-reference addresses WRA_{N} and any suitable number “M” of document-word address fields, such that document-word addresses ADDR_{N-1} up to ADDR_{N-M} are stored at word-reference address WRA_{N}. In one embodiment, each data structure address 140b includes 30-bits such that informer data structure 117a can include 10⁹ word-reference addresses and associated document-word addresses.

FIG. 7B is a diagram illustrating another embodiment of an informer data structure 117b. In one embodiment, informer data structure 117b provides informer data structure 114b of information storage system 110b previously described and illustrated with reference to FIG. 5. Informer data structure 117b stores document addresses in document address 1 (DOC ADDR_{—}1) through document address M (DOC ADDR_M) fields 144a-144(m) and word addresses in word address 1 (WORD ADDR_{—}1) through word address M (WORD ADDR_M) fields 146a-146(m) at data structure addresses 140b. Each word-reference address 134 stored in word reference data structure 112 corresponds to a data structure address 140b in informer data structure 117b. One or more document addresses D are stored at each data structure address 140b. One or more word addresses W are also stored at each data structure address 140b. Each document address and word address provides an address within document storage data structure 116 where the associated content 132 from word reference data structure 112 is used.

Document addresses D₀₋₁ up to D_{0-M} and word addresses W₀₋₁ up to W_{0-M} are stored at word-reference address WRA₀. The document addresses stored at a data structure address may be repeated since the same word may be used several times within a single document. For example, D₀₋₁, may equal D₀₋₂, which may equal D₀₋₃, etc. Likewise, document addresses D₁₋₁ up to D_{1-M} and word addresses W₁₋₁ up to W_{1-M} are stored at word-reference address WRA₁. Informer data structure 117b includes any suitable number “N” of word-reference addresses WRA_{N} and any suitable number “M” of document address and word address fields, such that document addresses D_{N-1} up to D_{N-M} and word addresses W_{N-1} up to W_{N-M} are stored at word-reference address WRA_{N}. In one embodiment, each data structure address 140b includes 30-bits such that informer data structure 117b can include 109 word-reference addresses and associated document addresses and word addresses.

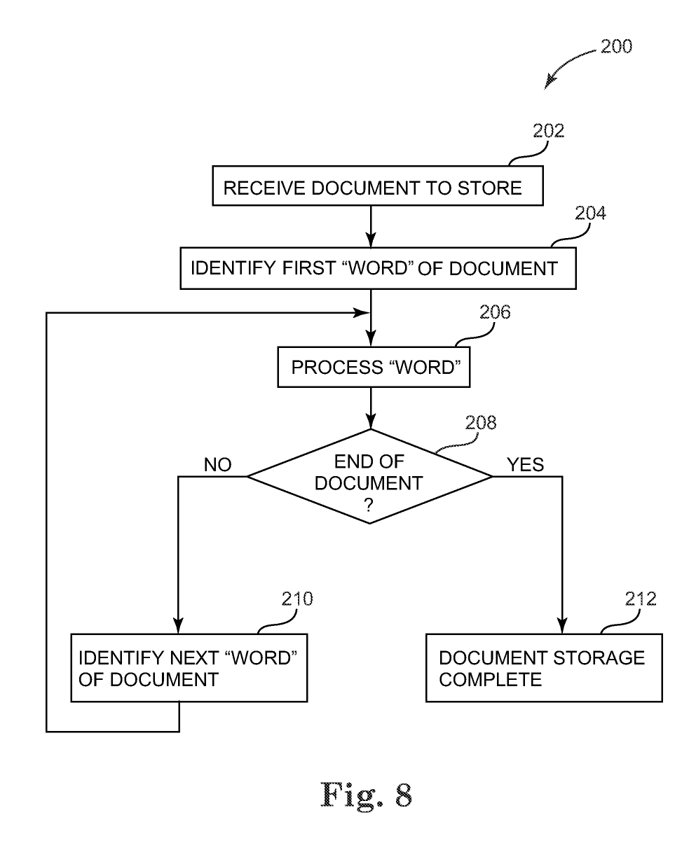

FIG. 8 is a flow diagram illustrating one embodiment of a method 200 for storing a document within information storage system 110a or 110b (generally referred to as information storage system 110). At 202, data loading and maintenance system 102 retrieves a document from a website or another suitable source. At 204, data loading and maintenance system 102 identifies the first “WORD” of the document. At 206, data loading and maintenance system 102 processes the “WORD” such that the “WORD” is stored in information storage system 110. Data loading and maintenance system 102 also stores the information used to directly access the “WORD” and the document in which the “WORD” is used in information storage system 110.

At 208, data loading and maintenance system 102 determines whether the end of the document has been reached. If the end of the document has not been reached, then at 210 data loading and maintenance system 102 identifies the next “WORD” within the document and repeats the word processing step at 206. If at 208, the end of the document has been reached, then at 212 the document storage is complete.

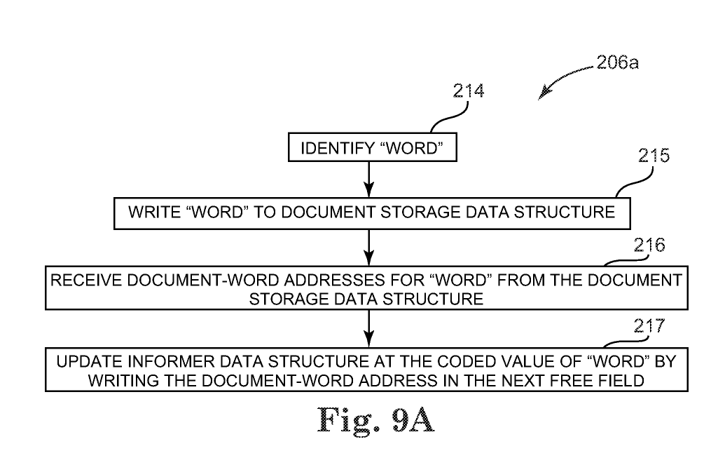

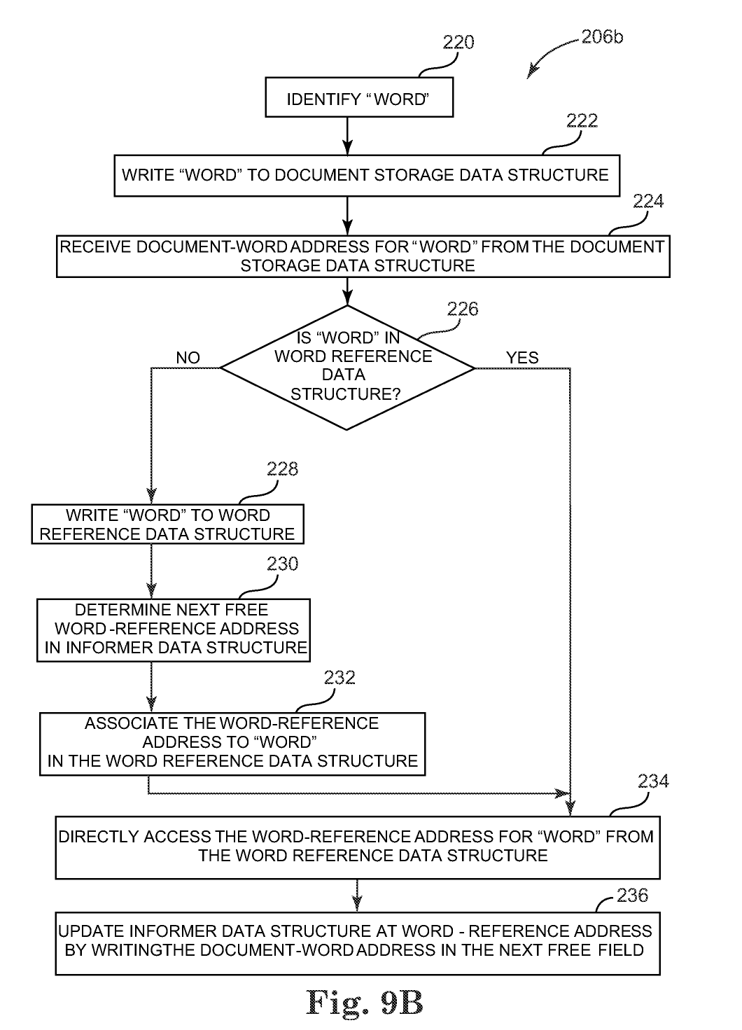

FIG. 9A is a flow diagram illustrating one embodiment of a method 206a for processing a word within a document being stored. In one embodiment, method 206a is used to process a word as indicated at 206 in FIG. 8 for information storage system 110a previously described and illustrated with reference to FIG. 1. At 214, data loading and maintenance system 102 identifies the current “WORD” to be processed. At 215, data loading and maintenance system 102 writes the “WORD” to document storage data structure 116 at the next available document-word address. At 216, data loading and maintenance system 102 receives the document-word address for the “WORD” from document storage data structure 116. At 217, data loading and maintenance system 102 updates the record in informer data structure 114a at the address defined by the coded value of “WORD” by writing the document-word address (for informer data structure 115a) in the next free field or the document address and word address (for informer data structure 115b) in the next free fields.

FIG. 9B is a flow diagram illustrating another embodiment of a method 206b for processing a word within a document being stored. In one embodiment, method 206b is used to process a word as indicated at 206 in FIG. 8 for information storage system 110b previously described and illustrated with reference to FIG. 5. At 220, data loading and maintenance system 102 identifies the current “WORD” to be processed. At 222, data loading and maintenance system 102 writes the “WORD” to document storage data structure 116 at the next available document-word address. At 224, data loading and maintenance system 102 receives the document-word address for the “WORD” from document storage data structure 116.

At 226, data loading and maintenance system 102 determines whether the “WORD” is already stored in word reference data structure 112. If the “WORD” is not already stored in word reference data structure 112, then at 228 data loading and maintenance system 102 writes the “WORD” to word reference data structure 112. The “WORD” is written to word reference data structure 112 at the address equal to the coded value of the “WORD”. At 230, data loading and maintenance system 102 determines the next free word-reference address in informer data structure 114b. At 232, data loading and maintenance system 102 associates the next free word-reference address to the “WORD” in word reference data structure 112. The next free word-reference address is associated to the “WORD” by writing the next free word-reference address to the record within word reference data structure 112 at the address equal to the coded value of the “WORD”.

If the “WORD” is already stored in word reference data structure 112 or after the “WORD” has been written to word reference data structure 112, at 234 data loading and maintenance system 102 directly accesses the word-reference address for the “WORD” in word reference data structure 112. The word-reference address is directly accessed at the address equal to the coded value of the “WORD”. At 236, data loading and maintenance system 102 updates the record in informer data structure 114b at the word-reference address by writing the document-word address (for informer data structure 117a) in the next free field or the document address and word address (for informer data structure 117b) in the next free fields.

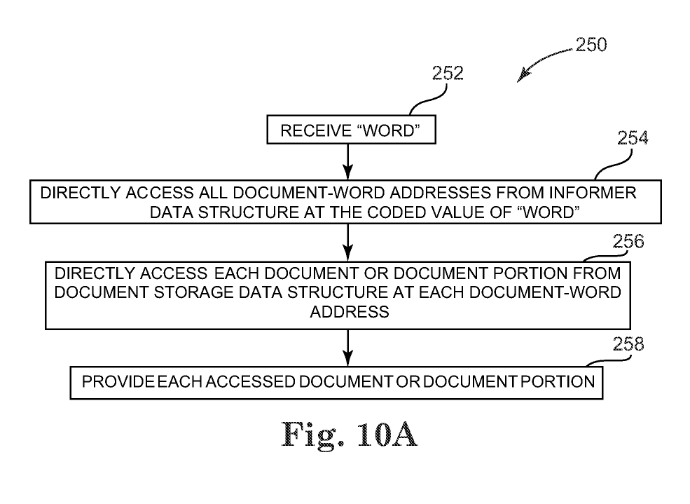

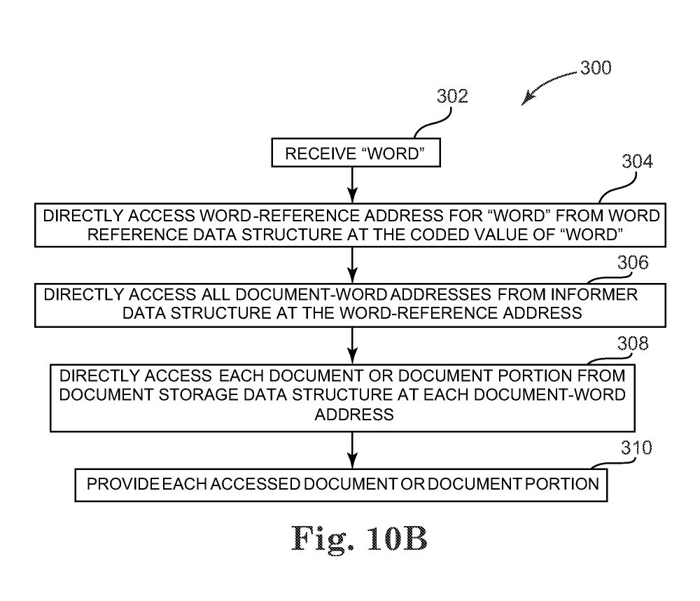

FIG. 10A is a flow diagram illustrating one embodiment of a method 250 for directly accessing stored documents in information storage system 110a previously described and illustrated with reference to FIG. 1. At 252, user interface 124 and processor 122 of a client 120 receive a search term or “WORD” for directly accessing documents including the search term or “WORD”. At 254, processor 122 of client 120 directly accesses informer data structure 114a at the coded value of the “WORD” and receives all the document-word addresses (for informer data structure 115a) or all the document addresses and word address (for informer data structure 115b) for the “WORD”. At 256, processor 122 directly accesses document storage data structure 116 at each received document-word address and receives each document or document portion that includes the “WORD”. At 258, processor 122 provides each accessed document or document portion to user interface 124.

In one embodiment, if the “WORD” does not have any document-word addresses associated with it, the “WORD” may be misspelled. In this case, processor 122 may implement any number of suitable processes to directly access documents stored in document storage data structure 116 that use a word most closely resembling the “WORD”. For example, in one embodiment, processor 122 directly accesses informer data structure 114a at the coded values of words having the first letter matching the first letter of the “WORD”. Processor 122 then directly accesses informer data structure 114a at the coded values of words having the first two letters matching the first two letters of the “WORD”. Processor 122 keeps adding letters and continues to directly access informer data structure 114a at the coded values of words having letters matching the letters of the “WORD” until no document-word addresses are found. At this point, processor 122 backs up one step and directly accesses the document-word addresses for all the words where the initial letters match the initial letters of the “WORD”.

FIG. 10B is a flow diagram illustrating one embodiment of a method 300 for directly accessing stored documents in information storage system 110b previously described and illustrated with reference to FIG. 5. At 302, user interface 124 and processor 122 of a client 120 receive a search term or “WORD” for directly accessing documents including the search term or “WORD”. At 304, processor 122 of client 120 directly accesses word reference data structure 112 at the address equal to the coded value of the “WORD” and receives the word-reference address for the “WORD”.

At 306, processor 122 directly accesses informer data structure 114b at the received word-reference address and receives all the document-word addresses (for informer data structure 117a) or all the document addresses and word address (for informer data structure 117b) for the “WORD”. At 308, processor 122 directly accesses document storage data structure 116 at each received document-word address and receives each document or document portion that includes the “WORD”. At 310, processor 122 provides each accessed document or document portion to user interface 124.

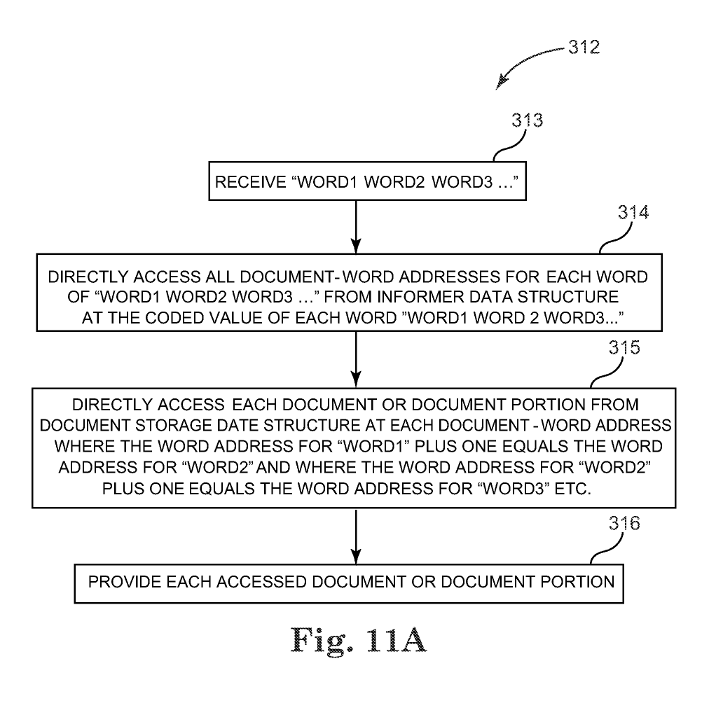

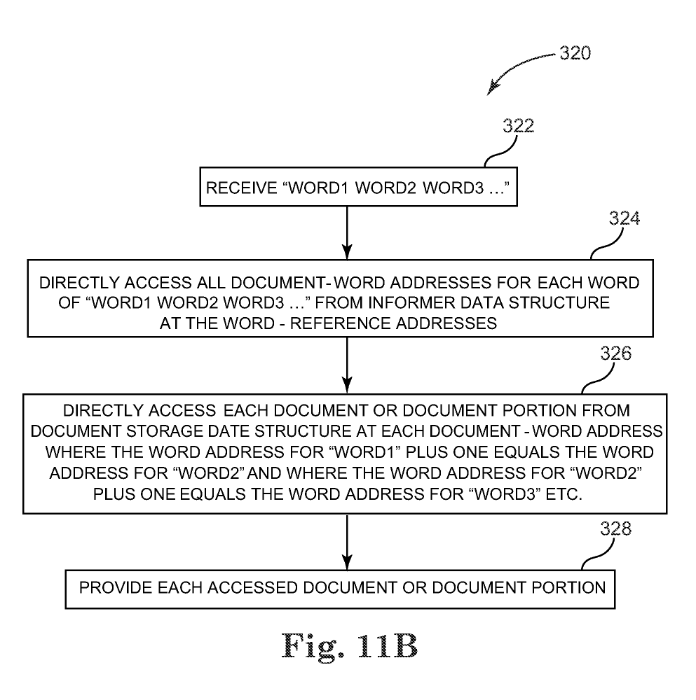

FIG. 11A is a flow diagram illustrating another embodiment of a method 312 for directly accessing stored documents within information storage system 110a previously described and illustrated with reference to FIG. 1. At 313, user interface 124 and processor 122 of a client 120 receive a search phrase including any suitable number of words, such as “WORD1 WORD2 WORD3 . . . ”. At 314, processor 122 of client 120 directly accesses informer data structure 114a at the addresses equal to the coded value of each word within “WORD1 WORD2 WORD3 . . . ” and receives all the document-word addresses (for informer data structure 115a) or all the document addresses and word addresses (for informer data structure 115b) for each word.

At 315, processor 122 directly accesses document storage data structure 116 at each received document-word address where the word address for “WORD1” plus one equals the word address for “WORD2” plus one, and where the word address for “WORD2” plus one equals the word address for “WORD3” and so on for each word within “WORD1 WORD2 WORD3 . . . ”. Processor 122 then receives each document or document portion that includes the phrase “WORD1 WORD2 WORD3 . . . ” at the directly accessed addresses. At 316, processor 122 provides each accessed document or document portion to user interface 124.

FIG. 11B is a flow diagram illustrating another embodiment of a method 320 for directly accessing stored documents within information storage system 110b previously described and illustrated with reference to FIG. 5. At 322, user interface 124 and processor 122 of a client 120 receive a search phrase including any suitable number of words, such as “WORD1 WORD2 WORD3 . . . ”. At 324, processor 122 of client 120 directly accesses word reference data structure 112 at the addresses equal to the coded value of each word within “WORD1 WORD2 WORD3 . . . ” and receives the word-reference addresses for each word. Processor 122 then directly accesses informer data structure 114b at each received word-reference address and receives all the document-word addresses (for informer data structure 117a) or all the document addresses and word addresses (for informer data structure 117b) for each word.

At 326, processor 122 directly accesses document storage data structure 116 at each received document-word address where the word address for “WORD1” plus one equals the word address for “WORD2” plus one, and where the word address for “WORD2” plus one equals the word address for “WORD3” and so on for each word within “WORD1 WORD2 WORD3 . . . ”. Processor 122 then receives each document or document portion that includes the phrase “WORD1 WORD2 WORD3 . . . ” at the directly accessed addresses. At 328, processor 122 provides each accessed document or document portion to user interface 124.

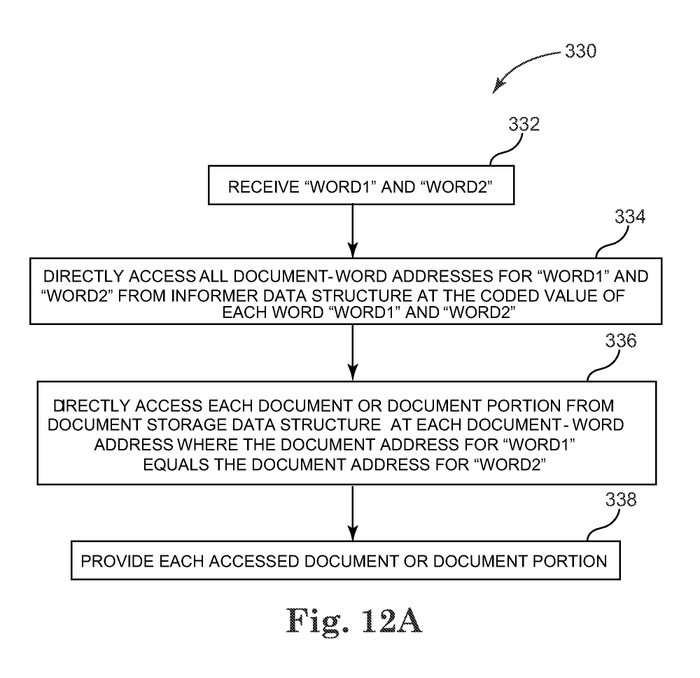

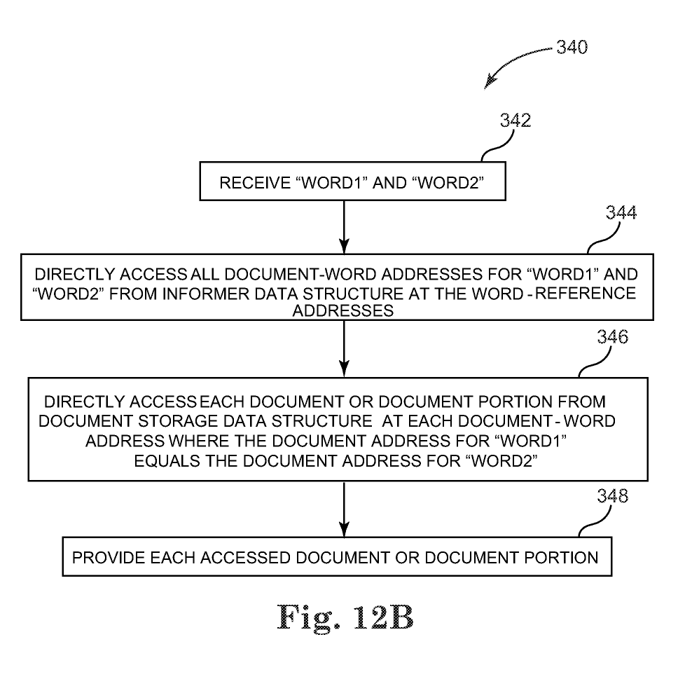

FIG. 12A is a flow diagram illustrating another embodiment of a method 330 for directly accessing stored documents within information storage system 110a previously described and illustrated with reference to FIG. 1. At 332, user interface 124 and processor 122 of a client 120 receive two or more search terms, such as “WORD1” and “WORD2”. At 334, processor 122 of client 120 directly accesses informer data structure 114a at the addresses equal to the coded value for each word “WORD1” and “WORD2” and receives all the document-word addresses (for informer data structure 115a) or all the document addresses and word addresses (for informer data structure 115b) for each word.

At 336, processor 122 directly accesses document storage data structure 116 at each received document-word address where the document address for “WORD1” equals the document address for “WORD2” and receives each document or document portion that includes both “WORD1” and “WORD2”. At 338, processor 122 provides each accessed document or document portion to user interface 124.

FIG. 12B is a flow diagram illustrating another embodiment of a method 340 for directly accessing stored documents within information storage system 110b previously described and illustrated with reference to FIG. 5. At 342, user interface 124 and processor 122 of a client 120 receive two or more search terms, such as “WORD1” and “WORD2”. At 344, processor 122 of client 120 directly accesses word reference data structure 112 at the addresses equal to the coded value for each word “WORD1” and “WORD2” and receives the word-reference addresses for each word. Processor 122 then directly accesses informer data structure 114b at each received word-reference address and receives all the document-word addresses (for informer data structure 117a) or all the document addresses and word addresses (for informer data structure 117b) for each word.

At 346, processor 122 directly accesses document storage data structure 116 at each received document-word address where the document address for “WORD1” equals the document address for “WORD2” and receives each document or document portion that includes both “WORD1” and “WORD2”. At 348, processor 122 provides each accessed document or document portion to user interface 124.

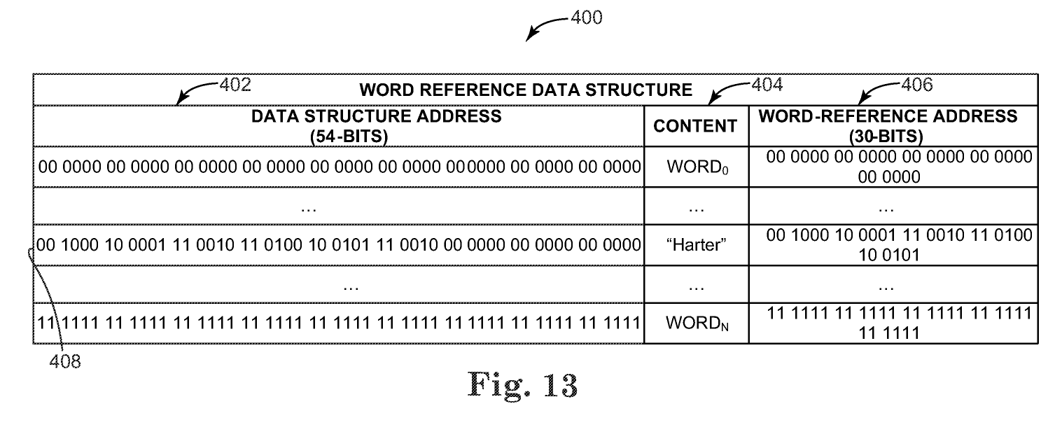

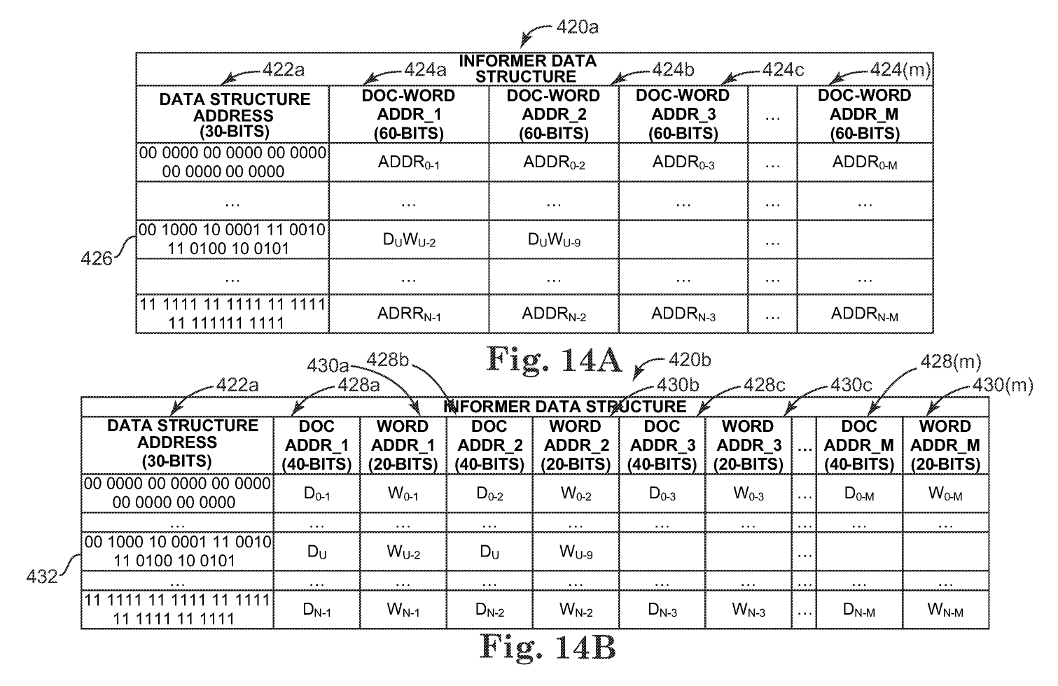

FIG. 13 is a diagram illustrating one embodiment of a word reference data structure 400 including example data. In one embodiment, word reference data structure 400 is used for word reference data structure 112 previously described and illustrated with reference to FIG. 5. Word reference data structure 140 stores content values 404 and 30-bit word-reference addresses 406 at 54-bit data structure addresses 402. In this embodiment, each data structure address 402 of word reference data structure 400 includes a 6-bit ASCII coded value of a word such that words having up to nine letters can be represented. For example, as indicated at 408, at address “00 1000 10 0001 11 0010 11 0100 10 0101 11 0010 00 0000 00 0000 00 0000”, which is the coded value for “Harter”, the word-reference address is “00 1000 10 0001 11 0010 11 0100 10 0101” FIG. 14A is a diagram illustrating one embodiment of an informer data structure 420a including example data. In one embodiment, informer data structure 420a is used for informer data structure 114b previously described and illustrated with reference to FIG. 5. Informer data structure 420a stores 60-bit document-word addresses in fields 424a-424(m) at 30-bit data structure addresses 422a. For example, as indicated at 426, at address “00 1000 10 0001 11 0010 11 0100 10 0101”, which is the word-reference address for “Harter”, a first 60-bit document-word address D_{U}W_{U-2} and a second 60-bit document-word address D_{U}W_{U-9} are stored. D_{U} represents the document address portion of the document-word addresses and W_{U-2} and W_{U-9} represent the word address portions of the document-word addresses.

FIG. 14B is diagram illustrating another embodiment of an informer data structure 420b including example data. In one embodiment, informer data structure 420b is used for informer data structure 1 14b previously described and illustrated with reference to FIG. 5. Informer data structure 420b stores 40-bit document addresses in fields 428a-428(m) and 20-bit word addresses 430a-430(m) at 30-bit data structure addresses 422a. For example, as indicated at 432, at address “00 1000 10 0001 11 0010 11 0100 10 0101”, which is the word-reference address for “Harter”, a first 40-bit document address D_{U}, a first 20-bit word address W_{U-2}, a second 40-bit document address D_{U}, and a second 40-bit word address W_{U-9} are stored. In this example, the first and second document addresses indicated at 432 are the same. In other embodiments, however, the first and second document addresses may be different, and additional document addresses may also be stored within the record.

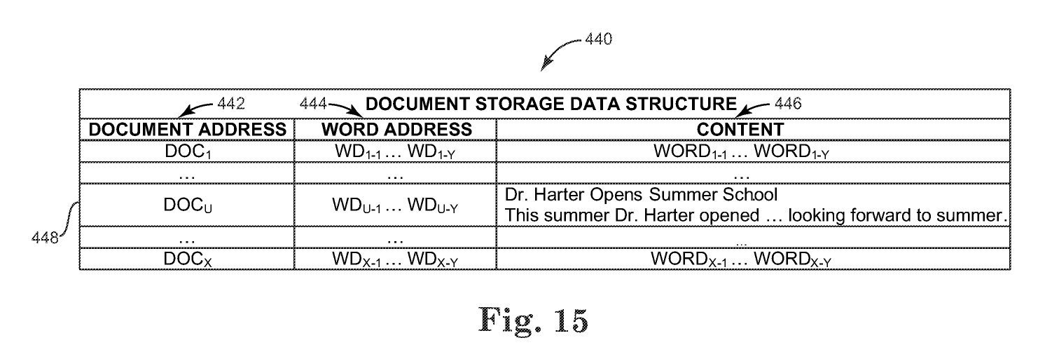

FIG. 15 is a diagram illustrating one embodiment of a document storage data structure 440 including example data. In one embodiment, document storage data structure 440 is used for document storage data structure 116 previously described and illustrated with reference to FIGS. 1 and 5. Document storage data structure 440 stores content 446 at document addresses 442 and word addresses 444. For example, as indicated at 448, the document “Dr. Harter Opens Summer School. This summer Dr. Harter opened . . . looking forward to summer.” is stored at document address DOC_{U}. Each word of the document is stored at a word address WD_{U-1} through WD_{U-Y}, respectively. Therefore, “Dr” is stored at WD_{U-1}, “Harter” is stored at WD_{U-2}, “Opens” is stored at WD_{U-3}, and so on to “summer”, which is stored at WD_{U-Y}.

In response to the search term “Harter” being received by a client 120 through user interface 124 or other suitable means, processor 122 directly accesses word-reference data structure 400 at the coded value for “Harter” and the word-reference address “00 1000 10 0001 11 0010 11 0100 10 0101” is received. In one embodiment, processor 122 directly accesses informer data structure 420a at the word-reference address and document-word addresses D_{U}W_{U-2} and D_{U}W_{U-9} are received. In another embodiment, processor 122 directly accesses informer data structure 420b at the word-reference address and document addresses and word addresses Du and W_{U-2} and Du and W_{U-9} are received. Processor 122 then directly accesses document storage data structure 440 at the document address D_{U}, which equals DOC_{U} in this embodiment, and at word addresses W_{U-2} and W_{U-9}, which equal WD_{U-2} and WD_{U-9}, respectively in this embodiment. The accessed document “Dr. Harter . . . ” or specified portions of the accessed document are returned to client 120. Therefore, the document including “Harter” is directly accessed without executing a search query on a processor of information storage system 110.

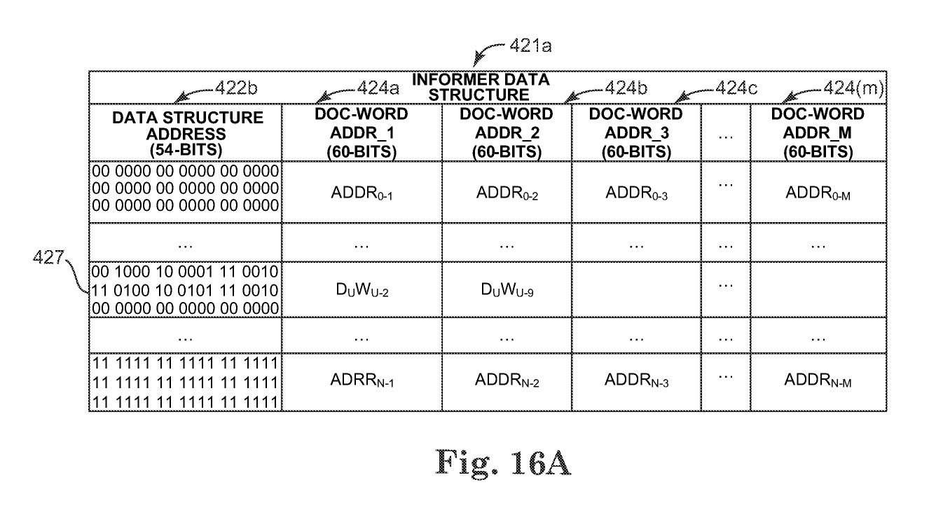

FIG. 16A is a diagram illustrating one embodiment of an informer data structure 421a including example data. In one embodiment, informer data structure 421a is used for informer data structure 114a previously described and illustrated with reference to FIG. 1. Informer data structure 421a stores 60-bit document-word addresses in fields 424a-424(m) at 54-bit data structure addresses 422b. For example, as indicated at 427, at address “00 1000 10 0001 11 0010 11 0100 10 0101 11 0010 00 00000 00 000 00 0000”, which is the coded value for “Harter”, a first 60-bit document-word address D_{U}W_{U-2} and a second 60-bit document-word address D_{U}W_{U-9} are stored. D_{U} represents the document address portion of the document-word addresses and W_{U-2} and W_{U-9} represent the word address portions of the document-word addresses.

FIG. 16B is a diagram illustrating another embodiment of an informer data structure 421b including example data. In one embodiment, informer data structure 421b is used for informer data structure 114a previously described and illustrated with reference to FIG. 1. Informer data structure 421b stores 40-bit document addresses in fields 428a-428(m) and 20-bit word addresses 430a-430(m) at 54-bit data structure addresses 422b. For example, as indicated at 433, at address “00 1000 10 00001 11 0010 11 0100 10 0101 11 0010 00 0000 00 0000 00 0000”, which is the coded value for “Harter”, a first 40-bit document address Du, a first 20-bit word address W_{U-2}, a second 40-bit document address D_{U}, and a second 40-bit word address W_{U-9} are stored. In this example, the first and second document addresses indicated at 433 are the same. In other embodiments, however, the first and second document addresses may be different, and additional document addresses may also be stored within the record.

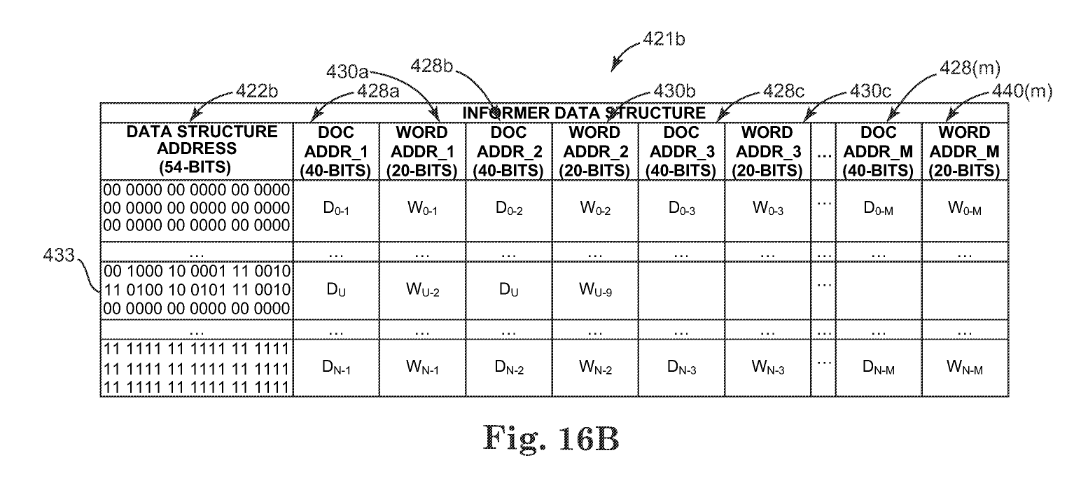

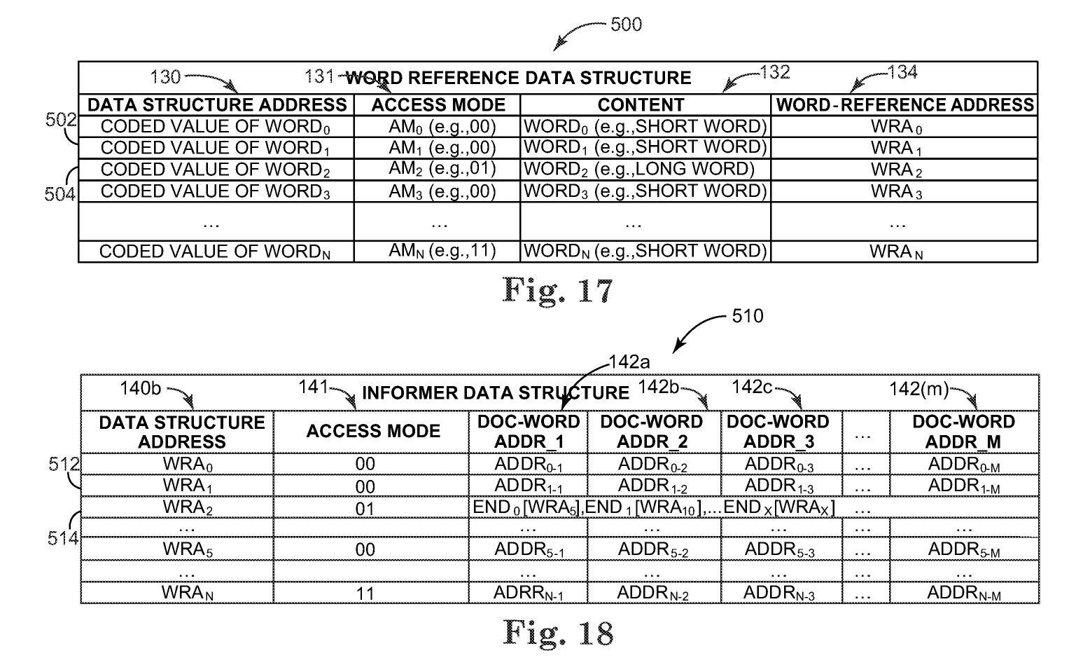

FIG. 17 is a diagram illustrating one embodiment of a word reference data structure 500 for handling long words. In one embodiment, word reference data structure 500 is used for word reference data structure 112 previously described and illustrated with reference to FIG. 5. As used herein, a “short word” is a word having a number of characters less than or equal to the maximum number of characters that when coded can define a data structure address 130. As used herein, a “long word” is a word having more characters than the maximum number of characters that when coded can define a data structure address 130. For example, for a 54-bit data structure address 130 using a 6-bit ASCII code, a word having nine characters or less is a short word and a word having ten or more characters is a long word.

Word reference data structure 500 stores word-reference addresses 134 for content 132 at data structure addresses 130. In addition, an access mode 131 is also stored at each data structure address 130. In one embodiment, the access mode 131 is the two least significant bits of the data structure address 130. Each address 130 of word reference data structure 500 is the coded value of the content 132 or the first portion of the content 132. In one embodiment, the coded value of the content is the ASCII value of the content or another suitable code, such as a Huffman code. In one embodiment, content 132 includes a list of words WORD₀ through WORD_{N} that are used in documents stored in document storage data structure 116.

WORD₀ is stored at the coded value of WORD₀ and is associated with word-reference address WRA₀ and access mode AM₀. Likewise, WORD₁ is stored at the coded value of WORD₁ and is associated with word-reference address WRA₁ and access mode AM₁. Word reference data structure 500 includes any suitable number “N” of words, such that WORD_{N} is stored at the coded value of WORD_{N} and is associated with word-reference address WRA_{N} and access mode AM_{N}. For each new word used in a document stored in document storage data structure 116, a new word-reference address is stored at the address in word reference data structure 500 that is equal to the coded value of the new word.

In one embodiment, the access mode 131 is a 2-bit value. A value of “00” indicates that the word stored at the address is a short word and a value of “01” indicates that the word stored at the address is a long word. For example, as indicated at 502, AM₁ equals “00” indicating that WORD₁ is a short word. As indicated at 504, AM₂ equals “01” indicating that WORD₂ is a long word. For long words, only the first portion of the word up to the number of bits of data structure address 130 is coded to provide data structure address 130.

FIG. 18 is a diagram illustrating one embodiment of an informer data structure 510 for handling long words. In one embodiment, informer data structure 510 is used for informer data structure 114b previously described and illustrated with reference to FIG. 5. Informer data structure 510 stores document-word addresses in document-word address 1 (DOC-WORD ADDR_{—}1) through document-word address M (DOC-WORD ADDR_M) fields 142a-142(m) at data structure addresses 140b. In addition, an access mode 141 is also stored at each data structure address 140b. For short words indicated by an access mode 141 equal to “00”, one or more document-word addresses ADDR are stored at each data structure address 140b. Each document-word address is an address within document storage data structure 116 where the associated content 132 from word reference data structure 500 is used.

Document-word addresses ADDR₀₋₁ up to ADDR_{0-M} are stored at word-reference address WRA₀. The document address portion of the document-word addresses ADDR₀₋₁ up to ADDR_{0-M} may be repeated since the same word may be used several times within a single document. Likewise, document-word addresses ADDR₁₋₁ up to ADDR_{1-M} are stored at word-reference address WRA₁ as indicated at 512. Informer data structure 510 includes any suitable number “N” of word-reference addresses WRA_{N} and any suitable number “M” of document-word address fields, such that document-word addresses ADDR_{N-1} up to ADDR_{N-M} are stored at word-reference address WRA_{N}.

For long words, as indicated by an access mode 141 equal to “01”, one or more word reference addresses are stored in document-word address fields 142a-142(m). The word reference addresses stored in document-word address fields 142a-142(m) are associated with one or more end portions of the long words. For example, as indicated at 514 for long word WORD₂ associated with word-reference address WRA₂, document-word address fields 142a-142(m) store a word reference address WRA₅ associated with END₀, WRA₁₀ associated with END₁, up to WRA_{X} associated with END_{X}, where “X” is any suitable number of end portions for WORD₂.

In this embodiment, when word-reference address WRA₂ is accessed, the access mode of “01” indicates that the word is a long word and that the record stores the end portions of the word. Processor 122 of client 120 searches through the end portions ENDO through END_{X} to find the correct end portion for the long word. Once the correct end portion is found, processor 122 directly accesses the word-reference address associated with the end portion to retrieve the document-word addresses for the long word. For example, for ENDO, the associated word-reference address is WRA₅. Therefore, word-reference address WRA₅ is accessed to retrieve document-word addresses ADDR₅₋₁ through ADDR_{5-M}.

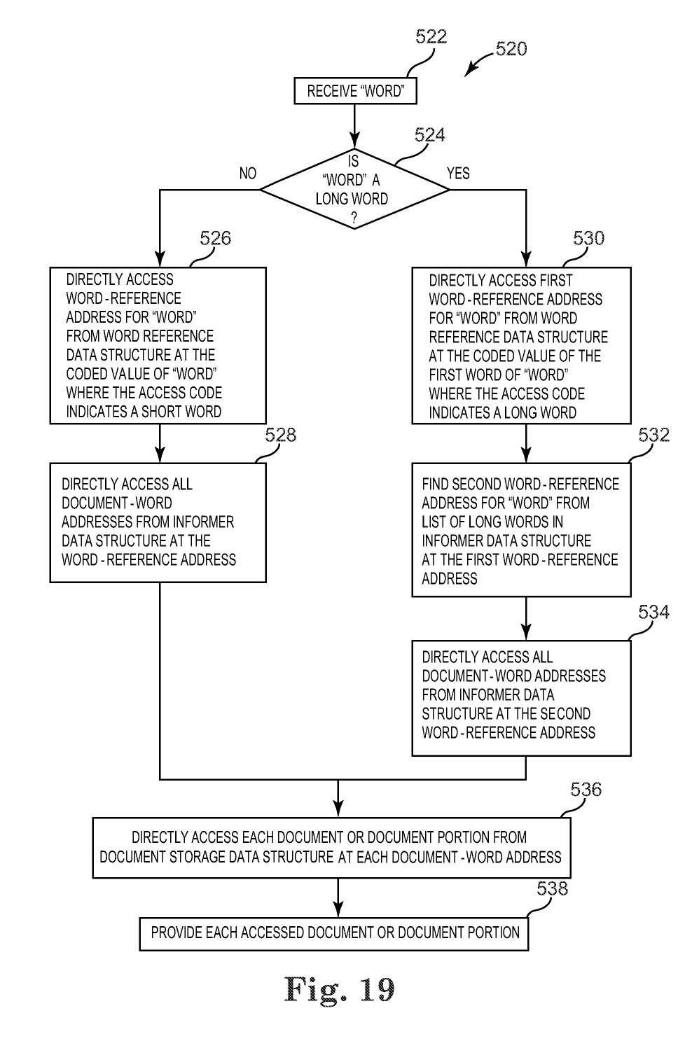

FIG. 19 is a flow diagram illustrating another embodiment of a method 520 for directly accessing stored documents including short or long words in information storage system 110b previously described and illustrated with reference to FIG. 5. At 522, user interface 124 and processor 122 of a client 120 receive a search term or “WORD” for directly accessing documents including the search term or “WORD”. At 524, processor 122 determines whether “WORD” is a short word or a long word.

If “WORD” is a short word, then at 526 processor 122 of client 120 directly accesses word reference data structure 500 at the address equal to the coded value of the “WORD” and where the access code indicates a short word and receives the word-reference address for “WORD”. At 528, processor 122 directly accesses informer data structure 510 at the received word-reference address and receives all the document-word addresses for the “WORD”.

If “WORD” is a long word, then at 530 processor 122 of client 120 directly accesses word reference data structure 500 at the address equal to the coded value of the first portion of “WORD” and where the access code indicates a long word and receives a first word-reference address for “WORD”. At 532, processor 122 directly accesses informer data structure 510 at the received first word-reference address and finds a second word-reference address for “WORD” from the list of long words or long word end portions. At 534, processor 122 directly accesses informer data structure 510 at the received second word-reference address and receives all the document-word addresses for the “WORD”.

At 536, processor 122 directly accesses document storage data structure 116 at each received document-word address and receives each document or document portion that includes the “WORD”. At 538, processor 122 provides each accessed document or document portion to user interface 124.

FIG. 20 is a diagram illustrating another embodiment of a word reference data structure 550 including example data. In one embodiment, word reference data structure 550 is used for word reference data structure 500 previously described and illustrated with reference to FIG. 17. In this embodiment, each data structure address 130 of word reference data structure 550 includes a 6-bit ASCII coded value of a word such that words having up to eight letters can be represented. As indicated at 552, “counter” has the access code “00” indicating “counter” is a short word. As indicated at 554, “counters” has the access code “01” indicating “counters” is the first portion of a long word. As indicated at 556, “countert” has the access code “01” indicating “countert” is the first portion of a long word.

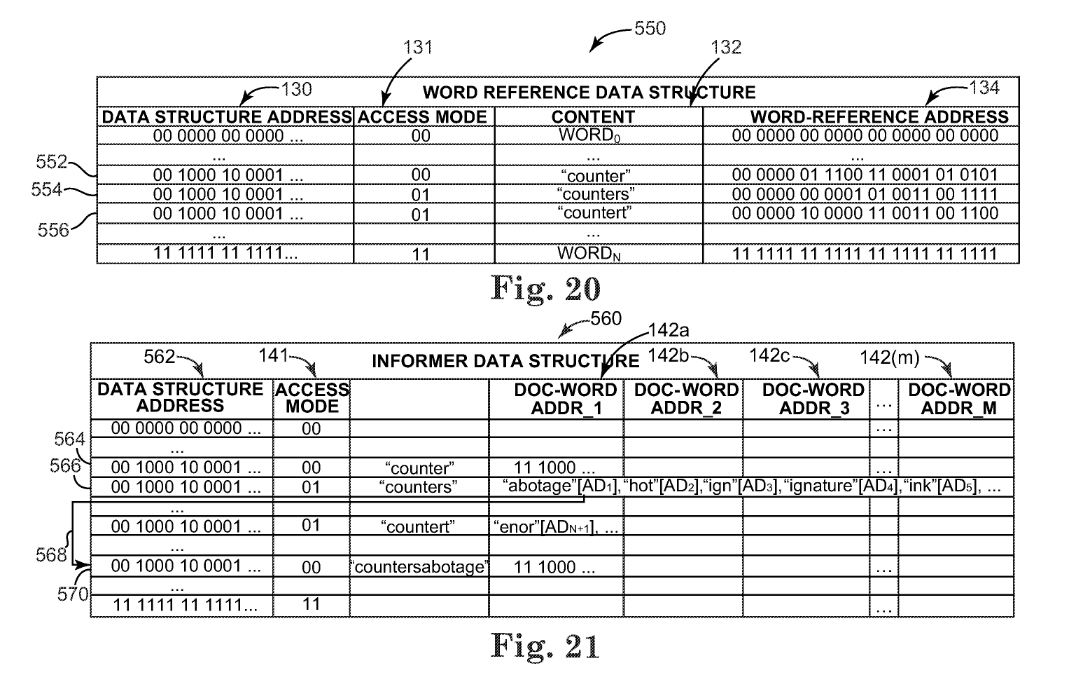

FIG. 21 is a diagram illustrating another embodiment of an informer data structure 560 including example data. In one embodiment, informer data structure 560 is used for informer data structure 510 previously described and illustrated with reference to FIG. 18. In one embodiment, each data structure address 562 is a word-reference address. In another embodiment, word-reference data structure 550 is not used and each data structure address 562 is the coded value of each word or the coded value of the first portion of each word.

As indicated at 564, the access mode equals “00” indicating that “counter” is a short word and therefore document-word addresses are stored at the associated data structure address. As indicated at 566, the access mode equals “01” indicating that “counters” is the first portion of a long word and therefore additional data structure addresses for the end portions of the word are stored at the associated data structure address. In this embodiment, data structure address AD₁ is associated with “abotage” for the long word “countersabotage.” Data structure address AD₂ is associated with “hot” for the long word “countershot.” Data structure address AD₃ is associated with “ign” for the long word “countersign.” Data structure address AD₄ is associated with “ignature” for the long word “countersignature.” Data structure address AD₅ is associated with “ink” for long word “countersink.” Any suitable number of data structure addresses can be associated with each end portion of “counters.” For the long word “countersabotage,” processor 122 of client 120 retrieves data structure address AD₁ and directly accesses the retrieved address as indicated at 568 to retrieve the document-word addresses as indicated at 570 for “countersabotage.”

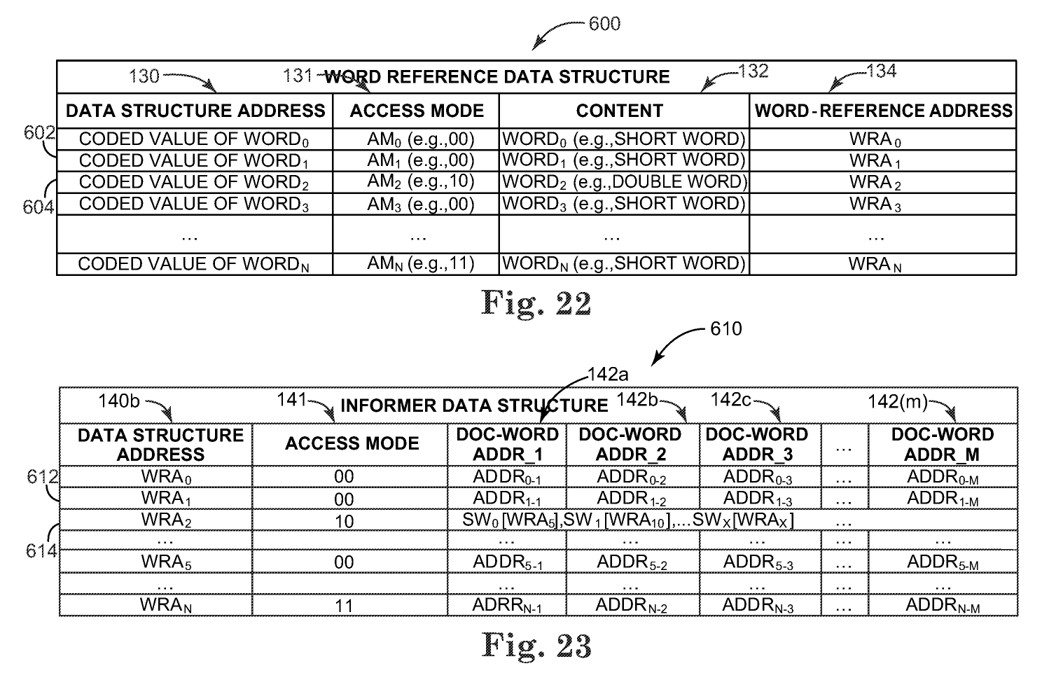

FIG. 22 is a diagram illustrating one embodiment of a word reference data structure 600 for handling double words. In one embodiment, word reference data structure 600 is used for word reference data structure 112 previously described and illustrated with reference to FIG. 5. As used herein, a “double word” is a word having two words where each word has a number of characters less than or equal to the maximum number of characters that when coded can define a data structure address 130.

Word reference data structure 600 stores word-reference addresses 134 for content 132 at data structure addresses 130. In addition, an access mode 131 is also stored at each data structure address 130. In one embodiment, the access mode 131 is the two least significant bits of the data structure address 130. Each address 130 of word reference data structure 600 is the coded value of the content 132. In one embodiment, the coded value of the content is the ASCII value of the content or another suitable code, such as a Huffman code. In one embodiment, content 132 includes a list of words WORD₀ through WORD_{N} that are used in documents stored in document storage data structure 116.

WORD₀ is stored at the coded value of WORD₀ and is associated with word-reference address WRA₀ and access mode AM₀. Likewise, WORD₁ is stored at the coded value of WORD₁ and is associated with word-reference address WRA₁ and access mode AM₁. Word reference data structure 600 includes any suitable number “N” of words, such that WORD_{N} is stored at the coded value of WORD_{N} and is associated with word-reference address WRA_{N} and access mode AM_{N}. For each new word used in a document stored in document storage data structure 116, a new word-reference address is stored at the address in word reference data structure 600 that is equal to the coded value of the new word.

In one embodiment, the access mode 131 is a 2-bit value. A value of “00” indicates that the word stored at the address is a short word and a value of “10” indicates that the word stored at the address is a double word. For example, as indicated at 602, AM₁ equals “00” indicating that WORD₁ is a short word. As indicated at 604, AM₂ equals “10” indicating that WORD₂ is a double word. For double words, only the first word of the double word is coded to provide data structure address 130.

FIG. 23 is a diagram illustrating one embodiment of an informer data structure 610 for handling double words. In one embodiment, informer data structure 610 is used for informer data structure 114b previously described and illustrated with reference to FIG. 5. Informer data structure 610 stores document-word addresses in document-word address 1 (DOC-WORD ADDR_{—}1) through document-word address M (DOC-WORD ADDR_M) fields 142a-142(m) at data structure addresses 140b. In addition, an access mode 141 is also stored at each data structure address 140b. For short words indicated by an access mode 141 equal to “00”, one or more document-word addresses ADDR are stored at each data structure address 140b. Each document-word address is an address within document storage data structure 116 where the associated content 132 from word reference data structure 600 is used.

Document-word addresses ADDR₀₋₁ up to ADDR_{0-M} are stored at word-reference address WRA₀. The document address portion of the document-word addresses ADDR₀₋₁ up to ADDR_{0-M} may be repeated since the same word may be used several times within a single document. Likewise, document-word addresses ADDR₁₋₁ up to ADDR_{1-M} are stored at word-reference address WRA₁ as indicated at 612. Informer data structure 610 includes any suitable number “N” of word-reference addresses WRA_{N} and any suitable number “M” of document-word address fields, such that document-word addresses ADDR_{N-1} up to ADDR_{N-M} are stored at word-reference address WRA_{N}.

For double words, as indicated by an access mode 141 equal to “10”, one or more word reference addresses are stored in document-word address fields 142a-142(m). The word reference addresses stored in document-word address fields 142a-142(m) are associated with one or more second words (SW) of the double words. For example, as indicated at 614 for double word WORD₂ associated with word-reference address WRA₂, document-word address fields 142a-142(m) store a word reference address WRA₅ associated with SW₀, WRA₁₀ associated with SW₁, up to WRA_{X} associated with SW_{X}, where “X” is any suitable number of second words for WORD₂.

In this embodiment, when word-reference address WRA₂ is accessed, the access mode of “10” indicates that the word is a double word and that the record stores the second words of the double word. Processor 122 of client 120 searches through the second words SW₀ through SW_{X} to find the correct second word of the double word. Once the correct second word is found, processor 122 directly accesses the word-reference address associated with the second word to retrieve the document-word addresses for the double word. For example, for SW₀, the associated word-reference address is WRA₅. Therefore, word-reference address WRA₅ is accessed to retrieve document-word addresses ADDR₅₋₁ through ADDR_{5-M}.

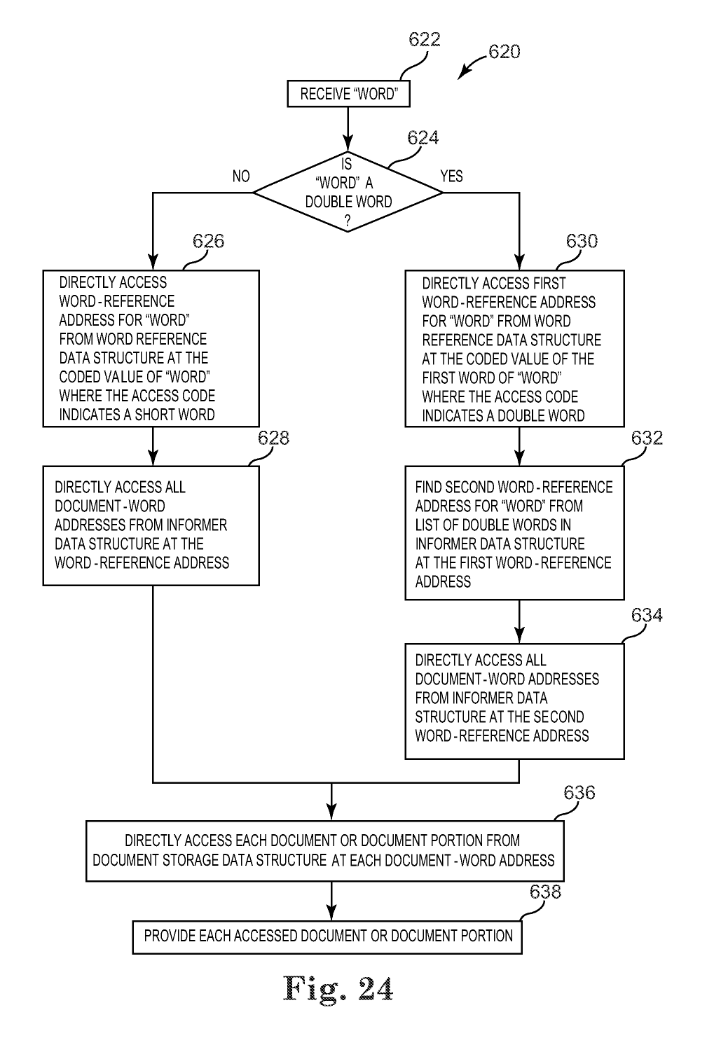

FIG. 24 is a flow diagram 620 illustrating another embodiment of a method for directly accessing stored documents including short or double words in information storage system 110b previously described and illustrated with reference to FIG. 5. At 622, user interface 124 and processor 122 of a client 120 receive a search term or “WORD” for directly accessing documents including the search term or “WORD”. At 624, processor 122 determines whether “WORD” is a short word or a double word.

If “WORD” is a short word, then at 626 processor 122 of client 120 directly accesses word reference data structure 600 at the address equal to the coded value of the “WORD” and where the access code indicates a short word and receives the word-reference address for “WORD”. At 628, processor 122 directly accesses informer data structure 610 at the received word-reference address and receives all the document-word addresses for the “WORD”.

If “WORD” is a double word, then at 630 processor 122 of client 120 directly accesses word reference data structure 600 at the address equal to the coded value of the first word of “WORD” and where the access code indicates a double word and receives a first word-reference address for “WORD”. At 632, processor 122 directly accesses informer data structure 610 at the received first word-reference address and finds a second word-reference address for “WORD” from the list of second words or double words. At 634, processor 122 directly accesses informer data structure 610 at the received second word-reference address and receives all the document-word addresses for the “WORD”.

At 636, processor 122 directly accesses document storage data structure 116 at each received document-word address and receives each document or document portion that includes the “WORD”. At 638, processor 122 provides each accessed document or document portion to user interface 124.

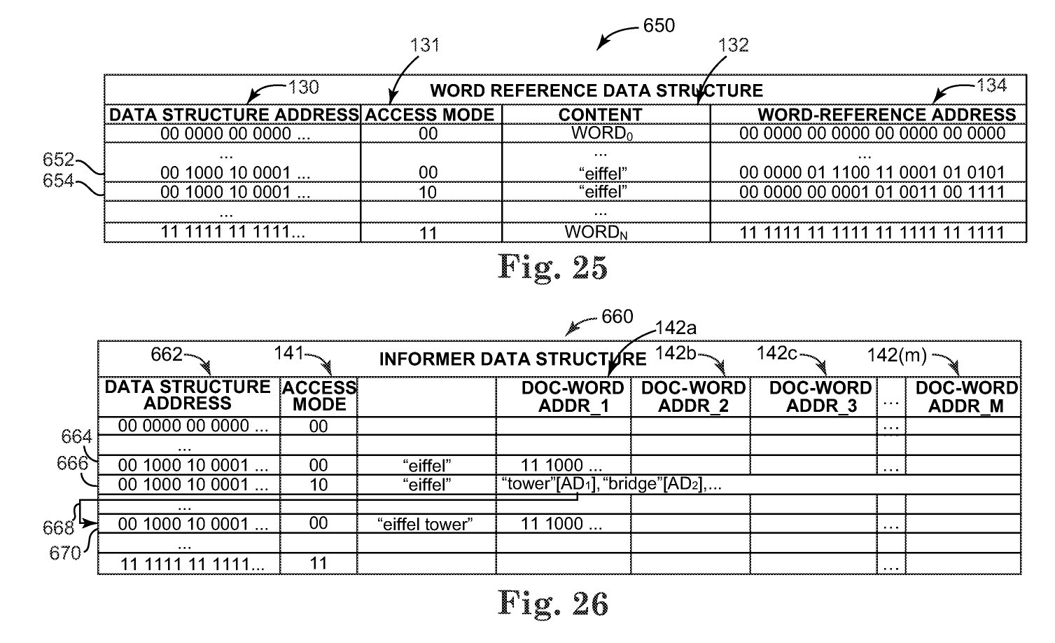

FIG. 25 is a diagram illustrating another embodiment of a word reference data structure 650 including example data. In one embodiment, word reference data structure 650 is used for word reference data structure 600 previously described and illustrated with reference to FIG. 22. In this embodiment, each data structure address 130 of word reference data structure 650 includes a 6-bit ASCII coded value of a word such that words having up to eight letters can be represented. As indicated at 652, “eiffel” has the access code “00” indicating “eiffel” is a short word. As indicated at 654, “eiffel” has the access code “10” indicating “eiffel” is the first word of a double word.

FIG. 26 is a diagram illustrating another embodiment of an informer data structure 660 including example data. In one embodiment, informer data structure 660 is used for informer data structure 610 previously described and illustrated with reference to FIG. 23. In one embodiment, each data structure address 662 is a word-reference address. In another embodiment, word-reference data structure 650 is not used and each data structure address 662 is the coded value of each word or the first word of each double word.

As indicated at 664, the access mode equals “00” indicating that “eiffel” is a short word and therefore document-word addresses are stored at the associated data structure address. As indicated at 666, the access mode equals “10” indicating that “eiffel” is the first word of a double word and therefore additional data structure addresses for the second words of the double word are stored at the associated data structure address. In this embodiment, data structure address AD₁ is associated with “tower” for the double word “eiffel tower.” Data structure address AD₂ is associated with “bridge” for the double word “eiffel bridge.” Any suitable number of data structure addresses can be associated with each second word for “eiffel.” For the double word “eiffel tower,” processor 122 of client 120 retrieves data structure address AD₂ and directly accesses the retrieved address as indicated at 668 to retrieve the document-word addresses as indicated at 670 for “eiffel tower.”

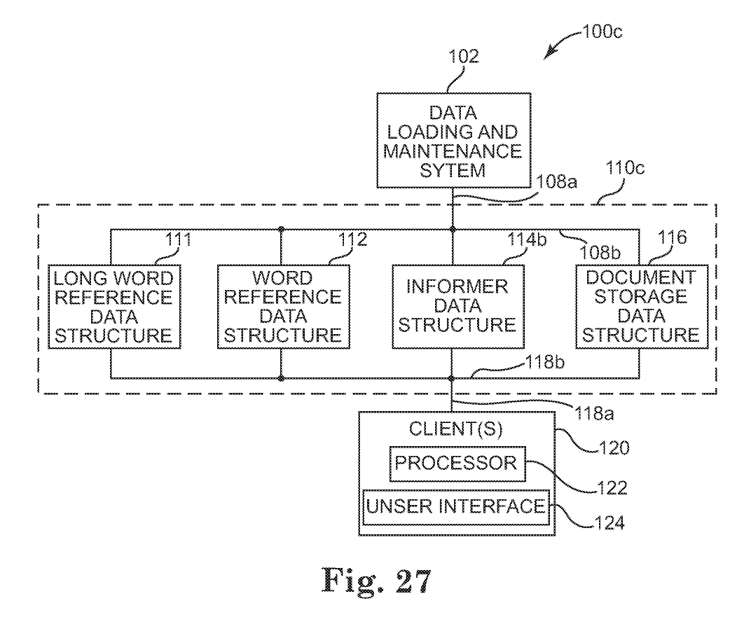

FIG. 27 is a block diagram illustrating another embodiment of an information storage and retrieval system 100c. Information storage and retrieval system 100c is similar to information storage and retrieval system 100b previously described and illustrated with reference to FIG. 5, except that information storage system 100b is replaced with information storage system 110c. Information storage system 110c includes a long word reference data structure 111, word reference data structure 112, an informer data structure 114b, and a document storage data structure 116.

Information storage system 110c stores documents for retrieval by clients 120. The documents are stored in document storage data structure 116 and are directly accessed by using addresses stored in informer data structure 114b, long word reference data structure 111, and word reference data structure 112. Clients 120 directly access the documents stored in document storage data structure 116. For short words, each client 120 directly accesses documents stored in document storage data structure 116 based on a coded value for each of one or more search terms provided by the client.

For short words, the coded value for each search term provides an address within word reference data structure 112 for obtaining an associated word-reference address from word reference data structure 112. For long words, each client 120 searches long word reference data structure 111 for each search term for obtaining an associated word-reference address. The word-reference address from long word reference data structure 111 or from word reference data structure 112 provides the address within informer data structure 114b for obtaining associated document-word addresses from informer data structure 114b. The document-word addresses from informer data structure 114b provide the addresses within document storage data structure 116 for obtaining associated documents or portions of documents from document storage data structure 116 that use the search terms. In this way, clients 120 directly access the documents or portions of documents based on the search terms. By directly accessing the documents, server based processors are not needed for processing queries to information storage system 110b. Therefore, the number of servers and the associated server farms may be reduced such that information storage and retrieval system 100c uses substantially less power than typical information storage and retrieval systems.

Data loading and maintenance system 102 searches websites and/or other suitable information sources for documents or other suitable content (e.g., multimedia files) to add to information storage system 110b. Data loading and maintenance system 102 provides the documents for writing to information storage system 110c. Data loading and maintenance system 102 writes the documents to document storage data structure 116 of information storage system 110c. Data loading and maintenance system 102 stores the document-word address for each usage of each word stored in document storage data structure 116 to informer data structure 114b at an associated word-reference address. For short words, data loading and maintenance system 102 stores each word-reference address in word reference data structure 112 at an associated address for each short word. The associated address for each short word is the coded value of the word. For longs words, data loading and maintenance system 102 stores each word-reference address in long word reference data structure 111 at an associated address for each long word.

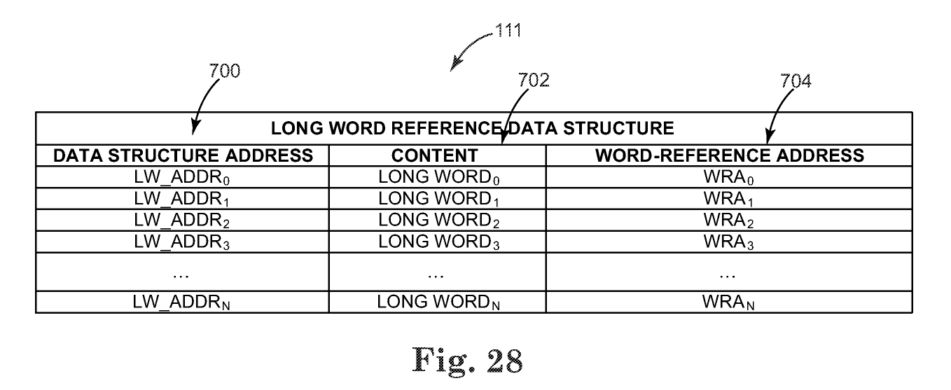

FIG. 28 is a diagram illustrating one embodiment of a long word reference data structure 111. Long word reference data structure 111 stores word-reference addresses 704 for content 702 at data structure addresses 700. LONG WORD₀ associated with word-reference address WRA₀ is stored at data structure address LW_ADDR₀. Likewise, LONG WORD₁ associated with word-reference address WRA₁ is stored at data structure address LW_ADDR₁. Long word reference data structure 111 includes any suitable number “N” of long words, such that LONG WORD_{N} associated with word-reference address WRA_{N} is stored at data structure address LW_ADDR_{N}. For each new long word used in a document stored in document storage data structure 116, a new word-reference address is stored in long word reference data structure 111.

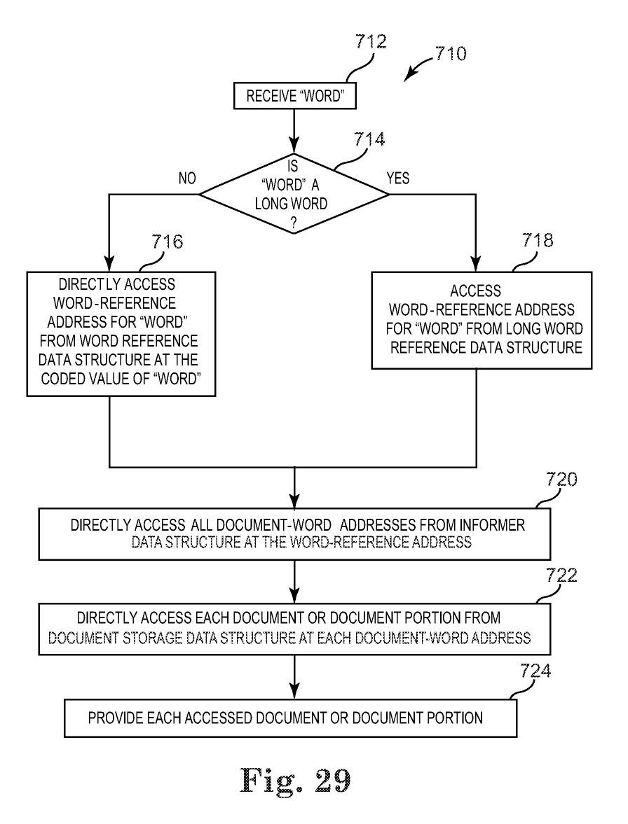

FIG. 29 is a flow diagram illustrating another embodiment of a method 710 for directly accessing stored documents including a short or long word in information storage system 110c previously described and illustrated with reference to FIG. 27. At 712, user interface 124 and processor 122 of a client 120 receive a search term or “WORD” for directly accessing documents including the search term or “WORD”. At 714, processor 122 determines whether “WORD” is a short word or a long word.

If “WORD” is a short word, then at 716 processor 122 of client 120 directly accesses word reference data structure 114b at the address equal to the coded value of the “WORD” and receives the word-reference address for “WORD”. If “WORD” is a long word, then at 718 processor 122 of client 120 accesses long word reference data structure 111 and retrieves the word-reference address associated with “WORD”.

At 720, processor 122 directly accesses informer data structure 114b at the received word-reference address and receives all the document-word addresses for the “WORD”. At 722, processor 122 directly accesses document storage data structure 116 at each received document-word address and receives each document or document portion that includes the “WORD”. At 724, processor 122 provides each accessed document or document portion to user interface 124.

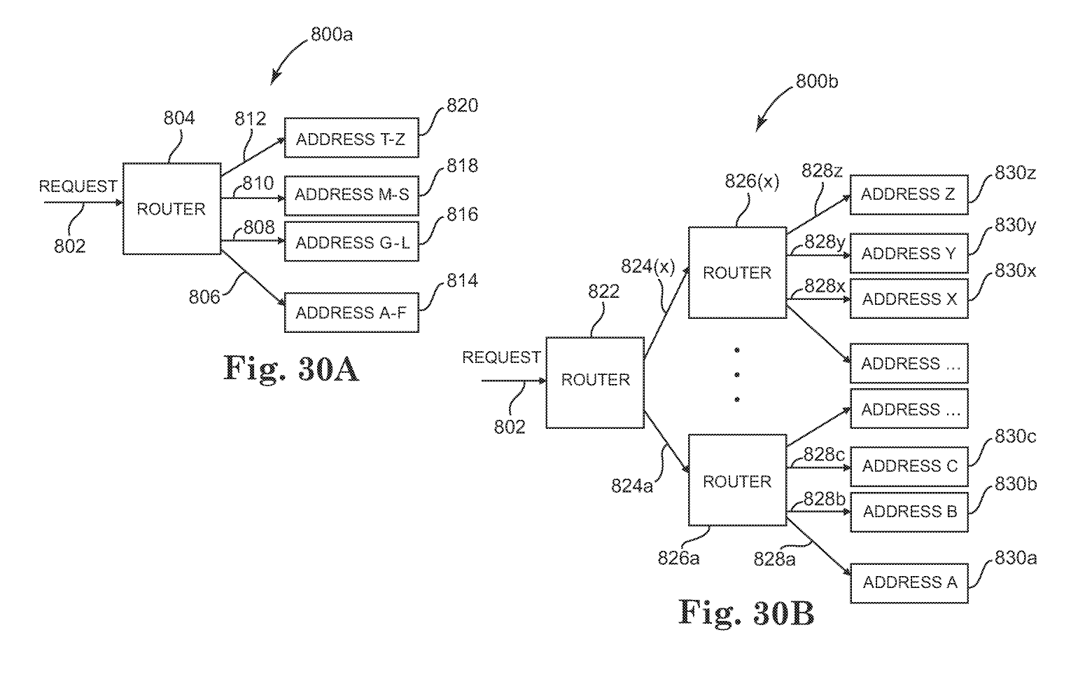

FIG. 30A is a block diagram illustrating one embodiment of hardware 800a for accessing stored documents in the information storage system 110a, 110b, or 110c. In one embodiment, hardware 800a provides informer data structure 114a previously described and illustrated with reference to FIG. 1 or word reference data structure 112 previously described and illustrated with reference to FIG. 5. Hardware 800a includes a router 804 and network storage devices 814, 816, 818, and 820. Router 804 receives a request from a client 120 on REQUEST communication link 802. Router 804 analyzes the request and forwards the request to the appropriate network storage device 814, 816, 818, or 820.

Network storage devices 814, 816, 818, and 820 include magnetic hard disk drives, flash-based solid-state drives, phase change random access memory (RAM) solid-state drives, resistive RAM solid-state drives, magnetic RAM solid-state drives, or other suitable network storage devices.

For a request including a word starting with a letter “a” through “f”, router 804 forwards the request to network storage device 814 though communication link 806. For a request including a word starting with a letter “g” through “l”, router 804 forwards the request to network storage device 816 though communication link 808. For a request including a word starting with a letter “m” through “s”, router 804 forwards the request to network storage device 818 though communication link 810. For a request including a word starting with a letter “t” through “z”, router 804 forwards the request to network storage device 820 though communication link 812. In other embodiments, other suitable numbers of network storage devices are used and the addresses are divided accordingly.

FIG. 30B is a block diagram illustrating another embodiment of hardware 800b for accessing stored documents in the information storage system 110a, 110b, or 110c. In one embodiment, hardware 800b provides informer data structure 114a previously described and illustrated with reference to FIG. 1 or word reference data structure 112 previously described and illustrated with reference to FIG. 5. Hardware 800b includes router 822, sub-routers 826a-826(x), and network storage devices 830a-830z, where “x” is any suitable number of routers. Router 822 receives a request from a client 120 on REQUEST communication link 802. Router 822 analyzes the request and forwards the request to the appropriate router 826a-826(x) through communication link 824a-824(x), respectively. Each router 826a-826(x) analyzes each received request and forwards the request to the appropriate network storage device 830a-830z coupled to the router via a communication link 828a-828z, respectively.

For example, for a request including a word starting with a letter “a,” router 822 forwards the request to router 826a through communication link 824a. Router 826a forwards the request to network storage device 830a though communication link 828a.

Each router 826a-826(x) is coupled to any suitable number of network storage devices 830a-830z. In other embodiments, other suitable numbers of sub-routers and network storage devices are used and the addresses are divided accordingly.

In another embodiment, information storage system 110a, 110b, and 110c use a server and an attached file system of an operating system (i.e., a Linux based file system) to directly access the requested information. The file system is built such that the data held in files is kept in data blocks. The data blocks are all of the same length and, although that length can vary between different file systems, the block size of a particular file system is set when it is created. Every file's size is rounded up to an integer number of blocks. If the block size is 1024-bytes, then a file of 1025-bytes will occupy two 1024-byte blocks. Not all of the blocks in the file system hold data, some are used to contain the information that describes the structure of the file system.

Linux defines the file system topology by describing each file in the system with an inode data structure. An inode describes which blocks the data within a file occupies as well as the access rights of the file, the file's modification times and the type of the file. Every file in the file system is described by a single inode and each inode has a single unique number identifying it. The inodes for the file system are all kept together in inode tables. Directories are special files (themselves described by inodes) that contain pointers to the inodes of their directory entries. Directories are special files that are used to create and hold access paths to the files in the file system.

The layout of the file system includes occupying a series of blocks in a block structured device. So far as each file system is concerned, block devices are just a series of blocks that can be read and written. A file system does not need to concern itself with where on the physical media a block should be put, that is the job of the device's driver. Whenever a file system needs to read information or data from the block device containing it, it requests that its supporting device driver reads an integer number of blocks. The file system divides the logical partition that it occupies into block groups.

Therefore, for example, each letter of a storage device or a set of storage devices can be assigned, |a>, |b>, |c>, or |ab> . . . |az> spanning the whole address space. Within the storage device the directories are arranged accordingly, such that there are directories labelled |a>, |ab>, |ac> where there could be further diversification such as |aba>, |abb>, |abc> . . . in directory |ab>. For example, the locations that contain the word “abbe” are located in the location |a|ab|abb|abbe> in the document “abbe.qi”, which is stored in the directory assigned to its name. In this case, the server will look up the document abbe.qi and return the content addresses given there.

Embodiments provide an information storage and retrieval system where documents stored within the system are directly accessed. No search queries are executed on processors of the information storage and retrieval system to access the stored documents. Therefore, the number of servers and associated server farms for executing search queries may be reduced. By reducing the number of servers and associated server farms, the amount of power consumed by the information storage and retrieval system is substantially reduced compared to typical information storage and retrieval systems.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

What is claimed is:

1. An information storage and retrieval system comprising:
a first data structure configured to store documents, each document including a plurality of data portions; and
a second data structure configured to store addresses to each document and data portion stored in the first data structure at addresses defined by an identity of each data portion.

2. The system of claim 1, further comprising:
a system configured to:
receive a first document;
identify a first data portion of the first document;
write the first data portion to the first data structure at a free first address;
and
update the second data structure at the address defined by the identity of the first data portion by writing the first address for the first data portion in a free field.

3. The system of claim 1, further comprising:
a client configured to access a document including a search term, the client configured to:
directly access the second data structure at an address defined by an identity of the search term to receive a first address for the search term; and
directly access a first document in the first data structure at the first address for the search term.

4. The system of claim 3, wherein the client is configured to:
directly access the second data structure at the address defined by the identity of the search term to receive a second address for the search term; and
directly access a second document in the first data structure at the second address for the search term.

5. The system of claim 1, further comprising:
a client configured to access a document including a first search term and a second search term, the client configured to:
directly access the second data structure at an address defined by an identity of the first search term to receive first addresses for the first search term;
directly access the second data structure at an address defined by an identity of the second search term to receive second addresses for the second search term; and
directly access a first document in the first data structure at an address where a document address portion of a first address for the first search term equals a document address portion of a first address for the second search term.

6. The system of claim 1, further comprising:
a client configured to access a document including a phrase including a first term directly followed by a second term, the client configured to:
directly access the second data structure at an address defined by an identity of the first search term to receive first addresses for the first search term;
directly access the second data structure at an address defined by an identity of the second search term to receive second addresses for the second search term; and
directly access a first document in the first data structure at an address where a first address for the first term plus one equals a first address for the second term.

7. An information storage and retrieval system comprising:
a first data structure configured to store a plurality of documents, each document including a plurality of words, each usage of each word stored at its own first address;
a second data structure configured to store the first addresses for each word in a record at a second address, each second address associated with one word; and
a third data structure configured to store each second address in a record at an address defined by a coded value of the one word associated with each second address.

8. The system of claim 7, further comprising:
a processor configured to:
receive a first document;
identify a first word of the first document;
write the first word to the first data structure at a free first address;
determine whether the first word is associated with a second address;
determine a free second address in the second data structure and store the free second address in a record of the third data structure at an address defined by a coded value of the first word in response to determining that the first word is not associated with a second address;
directly access the third data structure at the address defined by the coded value of the first word to receive the second address associated with the first word; and
update the second data structure at the second address associated with the first word by writing the first address for the first word in a free field.

9. The system of claim 7, further comprising:
a client configured to access a document including a search term, the client configured to:
directly access the third data structure at an address defined by a coded value of the search term to receive a second address associated with the search term;
directly access the second data structure at the second address associated with the search term to receive a first address for the search term; and
directly access a first document in the first data structure at the first address for the search term.

10. The system of claim 9, wherein the client is configured to:
directly access the second data structure at the second address associated with the search term to receive a second first address for the search term; and
directly access a second document in the first data structure at the second first address for the search term.

11. The system of claim 7, further comprising:
a client configured to access a document including a first search term and a second search term, the client configured to:
directly access the third data structure at an address defined by a coded value of the first search term to receive a second address associated with the first search term;
directly access the third data structure at an address defined by a coded value of the second search term to receive a second address associated with the second search term;
directly access the second data structure at the second address associated with the first search term to receive first addresses for the first search term;
directly access the second data structure at the second address associated with the second search term to receive first addresses for the second search term; and
directly access a first document in the first data structure at an address where a document address portion of a first address for the first search term equals a document address portion of a first address for the second search term.

12. The system of claim 7, further comprising:
a client configured to access a document including a phrase including a first term directly followed by a second term, the client configured to:
directly access the third data structure at an address defined by a coded value of the first term to receive a second address associated with the first term;
directly access the third data structure at an address defined by a coded value of the second term to receive a second address associated with the second term;
directly access the second data structure at the second address associated with the first term to receive first addresses for the first term;
directly access the second data structure at the second address associated with the second term to receive first addresses for the second term; and
directly access a first document in the first data structure at an address where a first address for the first term plus one equals a first address for the second term.

13. A method for storing and retrieving information, the method comprising:
storing a plurality of documents in a first data structure, each document including a plurality of data portions; and
storing addresses to each document and data portion stored in the first data structure in a second data structure at addresses defined by an identity of each data portion.

14. The method of claim 13, further comprising:
receiving a first document;
identifying a first data portion of the first document;
writing the first data portion to the first data structure at a free first address; and
updating the second data structure at an address defined by the identity of the first data portion by writing the first address for the first data portion in a free field.

15. The method of claim 13, further comprising:
directly accessing the second data structure at an address defined by an identity of a search term to receive a first address for the search term; and
directly accessing a first document in the first data structure at the first address for the search term.

16. The method of claim 15, further comprising:
directly accessing the second data structure at the address defined by the identity of the search term to receive a second address for the search term; and
directly accessing a second document in the first data structure at the second address for the search term.

17. The method of claim 13, further comprising:
directly accessing the second data structure at an address defined by an identity of a first search term to receive first addresses for the first search term;
directly accessing the second data structure at an address defined by an identity of a second search term to receive second addresses for the second search term; and
directly accessing a first document in the first data structure at an address where a document address portion of a first address for the first search term equals a document address portion of a second address for the second search term.

18. The method of claim 13, further comprising:
directly accessing the second data structure at an address defined by an identity of a first search term to receive first addresses for the first search term;
directly accessing the second data structure at an address defined by an identity of a second search term to receive second addresses for the second search term; and
directly accessing a first document in the first data structure at an address where a first address for the first term plus an offset given by a length of the first search term plus one equals a second address for the second term.

19. The method of claim 13, wherein storing addresses to each document and data portion stored in the first data structure comprises storing addresses to each document and data portion stored in the first data structure at addresses defined by a coded value for each data portion.

20. A method for storing and retrieving information, the method comprising:
storing a plurality of documents in a first data structure, each document including a plurality of words, the storing including storing each usage of each word at its own first address;
storing the first addresses for each word in a record at a second address in a second data structure, each second address associated with one word; and
storing each second address in a record at an address defined by a coded value for the one word associated with each second address in a third data structure.

21. The method of claim 20, further comprising:
receiving a first document;
identifying a first word of the first document;
writing the first word to the first data structure at a free first address;
determining whether the first word is associated with a second address;
determining a free second address in the second data structure and storing the free second address in a record of the third data structure at an address defined by a coded value of the first word in response to determining that the first word is not associated with a second address;
directly accessing the third data structure at the address defined by the coded value of the first word to receive the second address associated with the first word; and
updating the second data structure at the second address associated with the first word by writing the first address for the first word in a free field.

22. The method of claim 20, further comprising:
directly accessing the third data structure at an address defined by a coded value of a search term to receive a second address associated with the search term;
directly accessing the second data structure at the second address associated with the search term to receive a first address for the search term; and
directly accessing a first document in the first data structure at the first address for the search term.

23. The method of claim 22, further comprising:
directly accessing the second data structure at the second address associated with the search term to receive a second first address for the search term; and
directly accessing a second document in the first data structure at the second first address for the search term.

24. The method of claim 20, further comprising:
directly accessing the third data structure at an address defined by a coded value of a first search term to receive a second address associated with the first search term;
directly accessing the third data structure at an address defined by a coded value of a second search term to receive a second address associated with the second search term;
directly accessing the second data structure at the second address associated with the first search term to receive first addresses for the first search term;
directly accessing the second data structure at the second address associated with the second search term to receive first addresses for the second search term; and
directly accessing a first document in the first data structure at an address where a document address portion of a first address for the first search term equals a document address portion of a first address for the second search term.

25. The method of claim 20, further comprising:
directly accessing the third data structure at an address defined by a coded value of a first term to receive a second address associated with the first term;
directly accessing the third data structure at an address defined by a coded value of a second term to receive a second address associated with the second term;
directly accessing the second data structure at the second address associated with the first term to receive first addresses for the first term;
directly accessing the second data structure at the second address associated with the second term to receive first addresses for the second term; and
directly accessing a first document in the first data structure at an address where a first address for the first term plus an offset given by a length of the first term plus one equals a first address for the second term.
